(19) United States
(12) Patent Application Publication
(10) Pub. No.: US 2025/0330871 A1
(43) Pub. Date: Oct. 23, 2025

(54) AI BASED PDU SET PSI BASED DISCARD ENHANCEMENT

(71) Applicant: QUALCOMM Incorporated, San Diego, CA (US)

(72) Inventors: Diana MAAMARI, San Diego, CA (US); Prasada Veera Reddy KADIRI, San Diego, CA (US); Mickael MONDET, Louannec (FR); Sherif ELAZZOUNI, San Diego, CA (US); Sitaramanjaneyulu KANAMARLAPUDI, San Diego, CA (US)

(21) Appl. No.: 18/638,292

(22) Filed: Apr. 17, 2024

(51) Int. Cl. H04W 28/06; H04W 28/02

(52) U.S. Cl. CPC H04W 28/06; H04W 28/0268

(57) ABSTRACT

A method for wireless communication at a user equipment (UE) and related apparatus are provided. In the method, the UE determines a discard configuration for a discard process based on protocol data unit (PDU) set importance (PSI) associated with a set of data radio bearers (DRBs). The discard configuration includes a discard timer and discard information for each DRB in the set of DRBs. The UE further transmits, for a network entity, one or more data packets over the set of DRBs based on the discard configuration.

### TECHNICAL FIELD

The present disclosure relates generally to communication systems, and more particularly, to the enhancements for the discard operations based on the protocol data unit (PDU) set importance (PSI) in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to determine a discard configuration for a discard process based on protocol data unit (PDU) set importance (PSI) associated with a set of data radio bearers (DRBs), where the discard configuration includes a discard timer and discard information for each DRB in the set of DRBs; and transmit, for a network entity based on the discard configuration, one or more data packets over the set of DRBs.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to transmit, for a UE, a network configuration for a discard process based on PDU set importance (PSI) associated with a set of DRBs; and communicate, with the UE based on a discard configuration based on the network configuration, one or more data packets over the set of DRBs, where the discard configuration includes a discard timer and discard information for each DRB in the set of DRBs.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is an illustrative block diagram of an example machine learning (ML) model represented by an artificial neural network (ANN), in accordance with various aspects of the present disclosure.

FIG. 5 is a diagram illustrating an example of an artificial intelligence (AI) and machine learning (ML) (AI/ML) algorithm of a method of wireless communication.

FIG. 6 illustrates an example of extended reality (XR) traffic flows.

FIG. 7 is a diagram is a diagram illustrating an example of a protocol data unit (PDU) set importance (PSI) based discard activation/deactivation medium access control (MAC)-control element (MAC-CE) in accordance with various aspects of the present disclosure.

FIG. 8 is a diagram is a diagram 800 illustrating an example information element (IE) for controlling the PSI-based discard operations in accordance with various aspects of the present disclosure.

FIG. 9 is a diagram is a diagram 900 illustrating

FIG. 10 is a call flow diagram illustrating a method of wireless communication in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a UE in accordance with various aspects of the present disclosure.

FIG. 13 is a flowchart illustrating methods of wireless communication at a network entity in accordance with various aspects of the present disclosure.

FIG. 14 is a flowchart illustrating methods of wireless communication at a network entity in accordance with various aspects of the present disclosure.

FIG. 15 is a diagram illustrating an example of a hardware implementation for an example apparatus and/or UE.

FIG. 16 is a diagram illustrating an example of a hardware implementation for an example network entity.

### DETAILED DESCRIPTION

In wireless communication, data packets, such as a protocol data unit (PDU) or a service data unit (SDU), may be dropped under certain conditions, such as when their delay extends beyond a time threshold or when facing high network congestion. This process, which may be referred to as a PDU or SDU discard procedure or process, helps to reduce network traffic, thereby maintaining network performance and optimizing resource utilization. In some examples, the discard operations may be based on the PDU set importance (PSI), which provides priority levels (e.g., high and low) for discard purposes. The PSI-based discard process may be applied at the data radio bearer (DRB) level, and the network may activate or deactivate the discard process for individual DRBs through, for example, medium access control (MAC)-control element (MAC-CE) signaling. Example aspects presented herein provide methods and apparatus to enhance the PSI-based discard, enabling a user equipment (UE) to indicate which DRBs should be subject to the PSI-based discard process and introducing multiple PSI levels for improved control over the discard processes.

Various aspects relate generally to wireless communication. Some aspects more specifically relate to the enhancements for the discard operations based on PSI in wireless communication. In some examples, a UE determines a discard configuration for a discard process based on PSI associated with a set of DRBs. The discard configuration may include a discard timer and discard information for each DRB in the set of DRBs. The UE further transmits, for a network entity, one or more data packets over the set of DRBs based on the discard configuration. In some examples, the discard information for each DRB in the set of DRBs may include an activation or deactivation status for each DRB in the set of DRBs for the discard process based on the PSI. In some examples, the discard information may include one PSI level from multiple PSI levels for the discard process based on the PSI for each DRB in the set of DRBs. In some examples, the UE may determine the discard configuration based on an artificial intelligence/machine learning (AI/ML) model. In some examples, the UE may indicate, for the network entity, discard preference information for the discard process based on the PSI associated with the set of DRBs, and receive, from the network entity, a network configuration for the discard process based on the PSI. The network configuration may be based on the discard preference information, and the UE may determine the discard configuration based on the network configuration.

Particular aspects of the subject matter described in this disclosure can be implemented to realize one or more of the following potential advantages. In some examples, by allowing the UE to recommend or autonomously select DRBs for activation or deactivation of PSI-based discard, the described techniques may be used to prevent unnecessary data transmission, thereby conserving bandwidth and enabling more efficient use of transmission resources. In some examples, by providing differentiated PSI levels and PSI discard timers for discard purposes, the described techniques ensure that high-priority data is transmitted efficiently, thereby enhancing the user experience in latency-sensitive applications, such as extended-reality (XR) applications. In some examples, by leveraging AI/ML models to determine the discard configuration, the described techniques enable the UE to adjust the discard configurations based on real-time network conditions autonomously, ensuring wireless communication quality under various network congestion levels and bandwidth availability conditions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

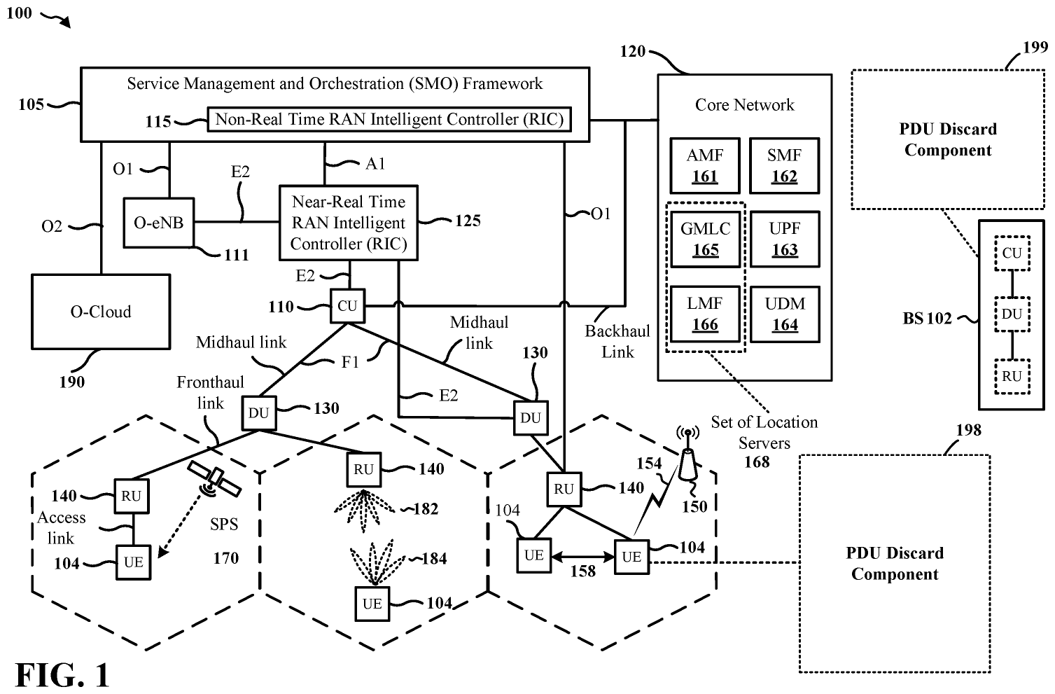

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the PDU discard component 198. The PDU discard component 198 may be configured to determine a discard configuration for a discard process based on PDU set importance (PSI) associated with a set of DRBs, where the discard configuration includes a discard timer and discard information for each DRB in the set of DRBs; and transmit, for a network entity based on the discard configuration, one or more data packets over the set of DRBs. In certain aspects, the base station 102 may include the PDU discard component 199. The PDU discard component 199 may be configured to transmit, for a UE, a network configuration for a discard process based on PSI associated with a set of DRBs; and communicate, with the UE based on a discard configuration based on the network configuration, one or more data packets over the set of DRBs, where the discard configuration includes a discard timer and discard information for each DRB in the set of DRBs. Although the following description may be focused on 5G NR, the concepts described herein may be applicable to other similar areas, such as LTE, LTE-A, CDMA, GSM, and other wireless technologies.

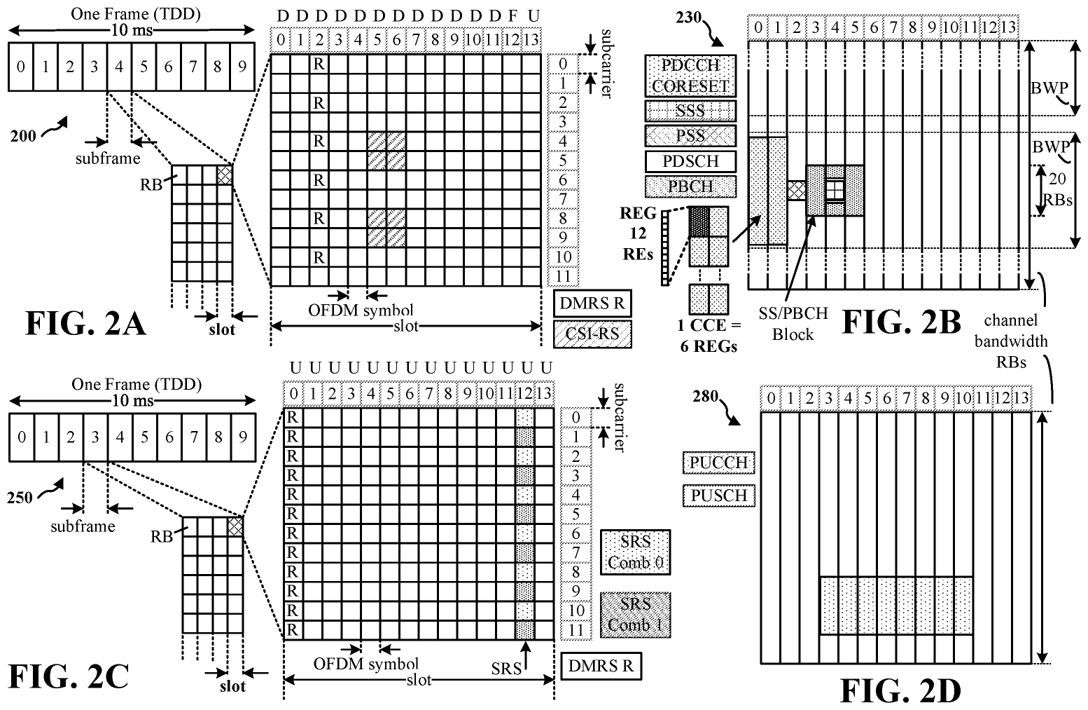

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δƒ = 2μ · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 24*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

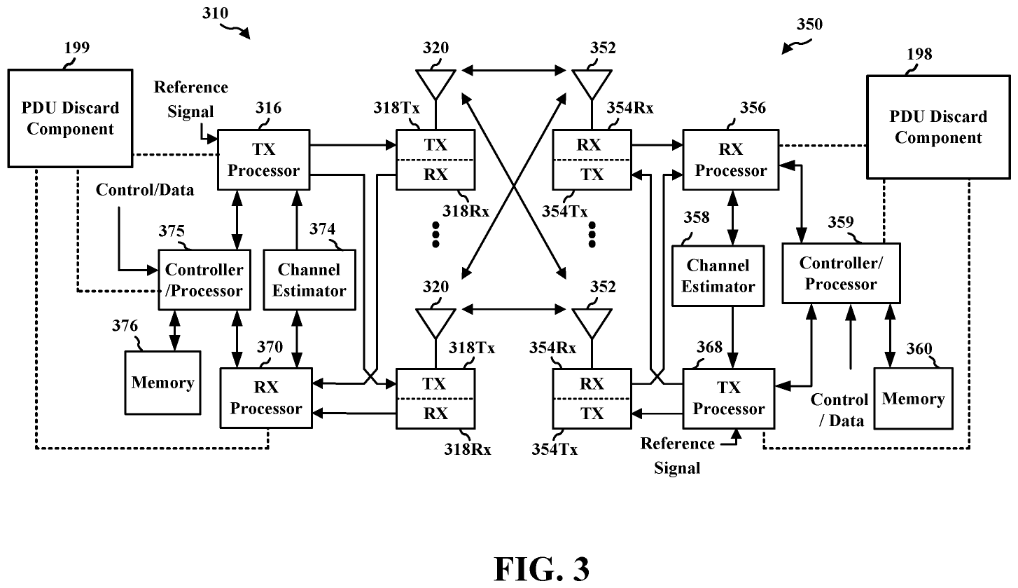

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the PDU discard component 198 of FIG. 1.

At least one of the TX processor 316, the RX processor 370, and the controller/processor 375 may be configured to perform aspects in connection with the PDU discard component 199 of FIG. 1.

Some aspects and techniques as described herein may be implemented, at least in part, using an artificial intelligence (AI) program, such as a program that includes a machine learning (ML) or artificial neural network (ANN) model. An example ML model may include mathematical representations or define computing capabilities for making inferences from input data based on patterns or relationships identified in the input data. As used herein, the term “inferences” can include one or more decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets that may indicate a starting point for the outputs of the ML model. An example ML model operating on input data may start at an initial output based on the biases and then update its output based on a combination of the input data and the weights.

In some aspects, an ML model may be configured to provide computing capabilities for wireless communications. Such an ML model may be configured with weights and biases to perform predictions regarding a set of resources (e.g., Set-A beams) based on measurements of another set of resources (e.g., Set-B beams). Thus, during the operation of a device, the ML model may receive input data (such as measurements associated with the first set of resources (e.g., Set-B beam measurements) and make inferences (such as predictions for Set-A beams) based on the weights and biases. The ML model may be employed to assist in beam management or beam selection using a reduced set of measurements.

ML models may be deployed in one or more devices (for example, network entities and user equipment (UE)) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of machine learning include supervised learning, unsupervised learning, semi-supervised learning, reinforcement learning, deep learning, etc. ML models may be used to perform different tasks, such as classification or regression, where classification refers to determining one or more discrete output values from a set of predefined output values, and regression refers to determining continuous values that are not bounded by predefined output values. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

The description herein illustrates, by way of some examples, how one or more tasks or problems in wireless communications may benefit from the application of one or more ML models for the prediction of one or more channel characteristics associated with a second set of resources using measurement of the aperiodic reference signal on a first set of resources based on a first mapping pattern. The first mapping pattern maps the first set of resources to the second set of resources, and the first mapping pattern and a second mapping pattern associated with an initial training meet one or more of a spatial domain consistency condition or a temporal domain consistency condition. To facilitate the discussion, an ML model configured using an ANN is used, but other types of ML models may be used instead of an ANN. Hence, unless expressly recited, subject matter regarding an ML model is not intended to be limited to an ANN solution. Unless otherwise specifically stated, terms such “AI/ML model,” “ML model,” “trained ML mode,” “ANN,” “model,” “algorithm,” or the like are intended to be interchangeable.

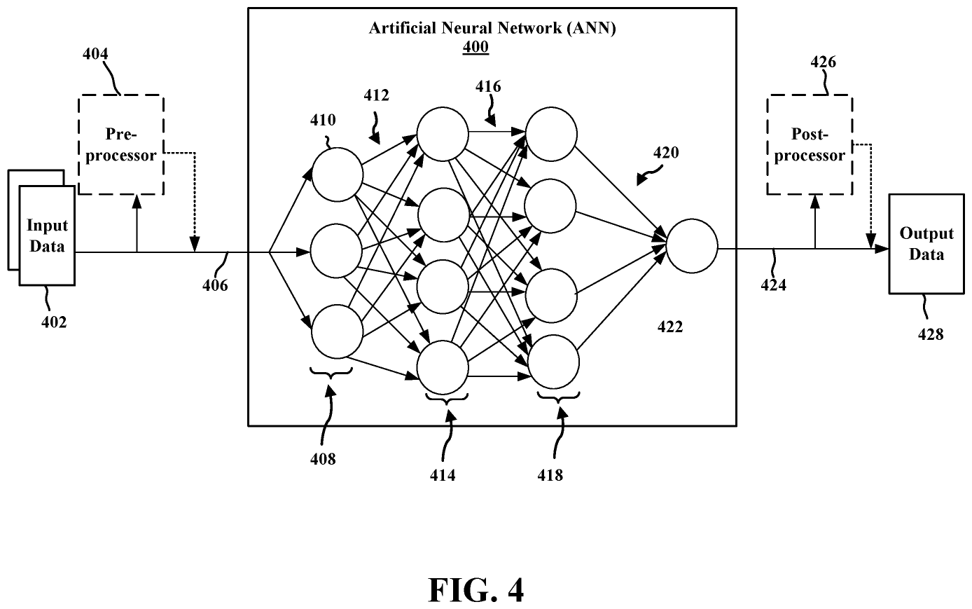

FIG. 4 is an illustrative block diagram of an example machine learning (ML) model represented by an artificial neural network (ANN) 400. ANN 400 may receive input data 406, which may include one or more bits of data A02, pre-processed data output from pre-processor 404 (optional), or some combination thereof. Here, data 402 may include training data, verification data, application-related data, or the like, based, for example, on the stage of deployment of ANN 400. Pre-processor 404 may be included within ANN 400 in some other implementations. Pre-processor 404 may, for example, process all or a portion of data 402, which may result in some of data 402 being changed, replaced, deleted, etc. In some implementations, pre-processor 404 may add additional data to data 402. In some implementations, the pre-processor 404 may be an ML model, such as an ANN. As an example, the input may include measurements performed on Set-B beams.

The ANN 400 includes at least one first layer 408 of artificial neurons 410 to process input data 406 and provide resulting first layer data via connections or “edges” such as edges 412 to at least a portion of at least one second layer 414. Second layer 414 processes data received via edges 412 and provides second layer output data via edges 416 to at least a portion of at least one third layer 418. Third layer 418 processes data received via edges 416 and provides third layer output data via edges 420 to at least a portion of a final layer 422, including one or more neurons to provide output data 424. All or part of output data 424 may be further processed in some manner by (optional) post-processor 426. Thus, in certain examples, ANN 400 may provide output data 428 that is based on output data 424, post-processed data output from post-processor 426, or some combination thereof. As an example, the output may include a set of resource (e.g., beam) predictions for Set-A beams. A base station or UE may then select a beam for use in transmission and/or reception based on the beam predictions for the Set-A beams output from the AI/ML model.

Post-processor 426 may be included within ANN 400 in some other implementations. Post-processor 426 may, for example, process all or a portion of output data 424, which may result in output data 428 being different, at least in part, from output data 424, as a result of data being changed, replaced, deleted, etc. In some implementations, post-processor 426 may be configured to add additional data to output data 424. In this example, second layer 414 and third layer 418 represent intermediate or hidden layers that may be arranged in a hierarchical or other like structure. Although not explicitly shown, there may be one or more further intermediate layers between the second layer 414 and the third layer 418. In some implementations, the post-processor 426 may be an ML model, such as an ANN.

The structure and training of artificial neurons 410 in the various layers may be tailored to the specific requirements of an application. Within a given layer, such as first layer 408, second layer 414, or third layer 418 of ANN 400, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” the artificial neurons of the next layer. Artificial neurons in such a layer may be activated by or be responsive to parameters such as the previously described weights and biases of ANN 400. The weights and biases of ANN 400 may be adjusted during a training process or during operation of ANN 400. The weights of the various artificial neurons may control the strength of connections between layers or artificial neurons, while the biases may control the direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data A06. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 400, may be conducted using training data. Training data may include one or more datasets that ANN 400 may use to identify patterns or relationships. Training data may represent various types of information, including written, visual, audio, environmental context, operational properties, etc. During training, the parameters (such as the weights and biases) of artificial neurons 410 may be changed, such as to minimize or otherwise reduce a loss function or a cost function. A training process may be repeated multiple times to fine-tune ANN 400 with each iteration.

Various ANN model structures are available for consideration. For example, in a feedforward ANN structure, each artificial neuron 410 in layer A14 receives information from the previous layer (such as one or more artificial neurons 410 in layer 408) and produces information for the next layer (such as one or more artificial neurons 410 in layer 418). In a convolutional ANN structure, some layers may be organized into filters that extract features from data, such as the training data or the input data. In a recurrent ANN structure, some layers may have connections that allow for the processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feedforward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, or other like processing.

Another example type of ANN structure is a model with one or more invertible layers. Models of this type may be inverted or “unwrapped” to reveal the input data that was used to generate the output of a layer. Other example types of ANN model structures include fully connected neural networks (FCNNs) and long short-term memory (LSTM) networks.

ANN 400 or other ML models may be implemented in various types of processing circuits along with memory and applicable instructions therein. For example, general-purpose hardware circuits, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed. In some implementations, the ML model may be implemented by an NPU or a TPU embedded in a system on chip (SoC) along with other components, such as one or more CPUs, GPUs, etc. A SoC includes several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs may also receive the inferences and be configured to perform certain actions based on the inferences produced by the ML model. The actions performed by the one or more CPUs may include sending commands to other components of the SoC or components external to the SoC to perform certain actions. For example, the CPU may send commands to an RF transceiver based on the outputs or inferences obtained from an ML model to cause the RF transceiver to operate on a wireless network in accordance with the ML model.

In some examples, an ML model may be trained prior to, or at some point following, operation of the ML model, such as ANN 400, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a user equipment (UE) or other device in a wireless communication system, or one or more network entities, or aggregated from multiple sources (such as a UE and a network entity/entities, one or more other UEs, the Internet, or the like). For example, wireless network architectures, such as self-organizing networks (SON) or mobile drive test (MDT) networks, may be adapted to support the collection of data for ML model applications. In another example, training data may be generated or collected online, offline, or both online and offline by a UE, network entity, or other device(s), and all or part of such training data may be transferred or shared (in real or near-real time), such as through store and forward functions or the like.

Offline training may refer to creating and using a static training dataset, such as in a batched manner, whereas online training may refer to the real-time collection and use of training data. For example, an ML model at a network device (such as a UE) may be trained or fine-tuned using online or offline training. For offline training, data collection and training can occur in an offline manner at the network side (such as at a base station or other network entity) or at the UE side. For online training, the training of a UE-side ML model may be performed locally at the UE or by a server device (such as a server hosted by a UE vendor) in a real-time or near-real-time manner based on data provided to the server device from the UE. In certain instances, all or part of the training data may be shared within a wireless communication system or even shared (or obtained from) outside of the wireless communication system.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, retraining it on the data, or using different optimization techniques, etc.

As part of a training process, parameters affecting the functioning of the artificial neurons and layers may be adjusted. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases to reduce or minimize the loss function, which can improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust the learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an ongoing training process early, such as when a performance of the model using a validation dataset starts to degrade.

Another example technique includes data augmentation to generate additional training data by applying transformations to all or part of the training information. A transfer learning technique may be used which involves using a pre-trained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ANN is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve the efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that is transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment and less aggressively prune the model for use in a high-power or high-bandwidth environment. In certain example implementations, pruning techniques may also be applied to training data, for example, to remove outliers. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting or otherwise improve the performance of the trained model.

One or more of the example training techniques presented above may be employed as part of a training process. Some example training processes that may be used to train an ANN include supervised learning, unsupervised learning, semi-supervised learning, and reinforcement learning techniques. With supervised learning, a model is trained on a labeled training dataset, wherein the input data is accompanied by a correct or otherwise acceptable output. With unsupervised learning, a model is trained on an unlabeled training dataset, such that the model will learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize the behavior of a model deployed in a dynamically changing environment, such as a wireless communication network.

Distributed, shared, or collaborative learning techniques may be used for the training process. For example, techniques such as federated learning may be used to decentralize the training process and rely on multiple devices, network entities, or organizations for training various versions or copies of an ML model without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ANN to be trained on data collected from a wide range of devices and environments. For example, an ANN may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a global or shared model and perform local training on the local model using locally available training data. The UE may provide updated information regarding the locally trained model to one or more other devices (such as a network entity or a server), where the updates from other-like devices (such as other UEs) may be aggregated and used to provide an update to the global or shared model. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to an ML model's usage, maintenance, activation, reporting, or the like. In certain instances, all or part of a dataset or model may be shared across multiple devices to provide or otherwise augment or improve processing. In some examples, signaling mechanisms may be utilized at various nodes of wireless networks to signal the capabilities for performing specific functions related to ML models, support for specific ML models, capabilities for gathering, creating, and transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as a UE, a network entity such as a base station, or a disaggregated network entity such as a central unit (CU), a distributed unit (DU), a radio unit (RU), or the like.

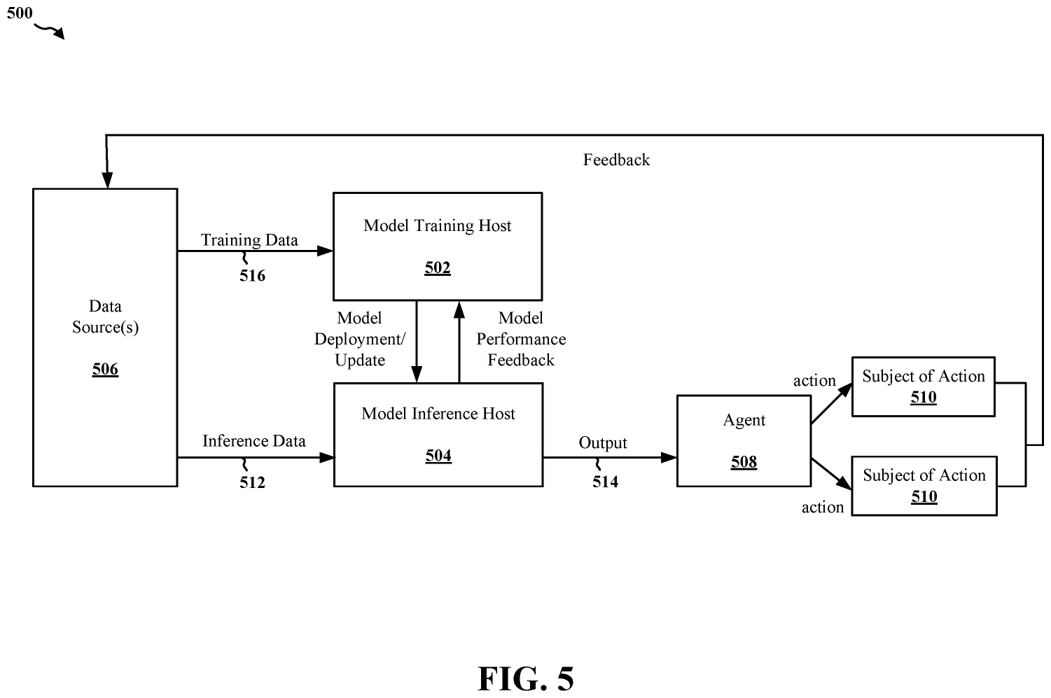

FIG. 5 is an illustrative block diagram of an example ML architecture 500 that may be used for wireless communications in any of the various implementations, processes, environments, networks, or use cases listed above. As illustrated, architecture 500 includes multiple logical entities, such as model training host 502, model inference host 504, data source(s) 506, and agent 508. Model inference host 504 is configured to run an ML model based on inference data 512 provided by data source(s) 506. Model inference host 504 may produce output 514, which may include a prediction or inference, such as a discrete or continuous value based on inference data 512, which may then be provided as input to the agent 508.

Agent 508 may represent an element or an entity of a wireless communication system including, for example, a radio access network (RAN), a wireless local area network, a device-to-device (D2D) communications system, etc. As an example, agent 508 may be a user equipment (such as UE 104, referring to FIG. 1, for example), a base station (such as base station 102, referring to FIG. 1, for example), or a disaggregated network entity (such as a CU 110, DU 130, or RU 140 in FIG. 1), an access point, a wireless station, a RAN intelligent controller (RIC) in a cloud-based RAN, among some examples. Additionally, agent 508 may also be a type of agent that depends on the type of tasks performed by model inference host 504, the type of inference data 512 provided to model inference host 504, or the type of output 514 produced by model inference host 504. As an example, the input may be measurements associated with a set of resources (e.g., Set-B beams/resources), and the output may include a set of predictions for a different set of resources (e.g., Set-A beams/resources). A base station or UE may then select a beam for use in transmission and/or reception based on the beam predictions for the Set-A beams output from the AI/ML model.

Agent 508 may perform one or more actions associated with receiving output 514 from model inference host 504, e.g., selection, use, and/or reporting regarding the predictions made for the different set of resources (e.g., Set-A beams/resources). Agent 508 may indicate the one or more actions performed to at least one subject of action 510. In some cases, agent 508 and the subject of action 510 are the same entity.

Data can be collected from data sources 506, and may be used as training data 516 for training an ML model, or as inference data 512 for feeding an ML model inference operation. Data sources 506 may collect data from various subject of action 510 entities (such as the UE or the network entity) and provide the collected data to a model training host 502 for ML model training. In some examples, if output 514 provided to agent 508 is inaccurate (or the accuracy is below an accuracy threshold), model training host 502 may provide feedback to model inference host 504 to modify or retrain the ML model used by model inference host 504, such as via an ML model deployment update.

Model training host 502 may be deployed at the same or a different entity than that in which model inference host 504 is deployed. For example, in order to offload model training processing, which can impact the performance of model inference host 504, model training host 502 may be deployed at a model server.

Extended reality (XR) traffic may refer to wireless communications for technologies such as virtual reality (VR), mixed reality (MR), and augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In some examples, an AR system may overlay sensory information (e.g., images) onto a natural environment and/or mask real objects from the natural environment. XR traffic may include video data and/or audio data. XR traffic may be transmitted by a base station and received by a UE, or the XR traffic may be transmitted by a UE and received by a base station.

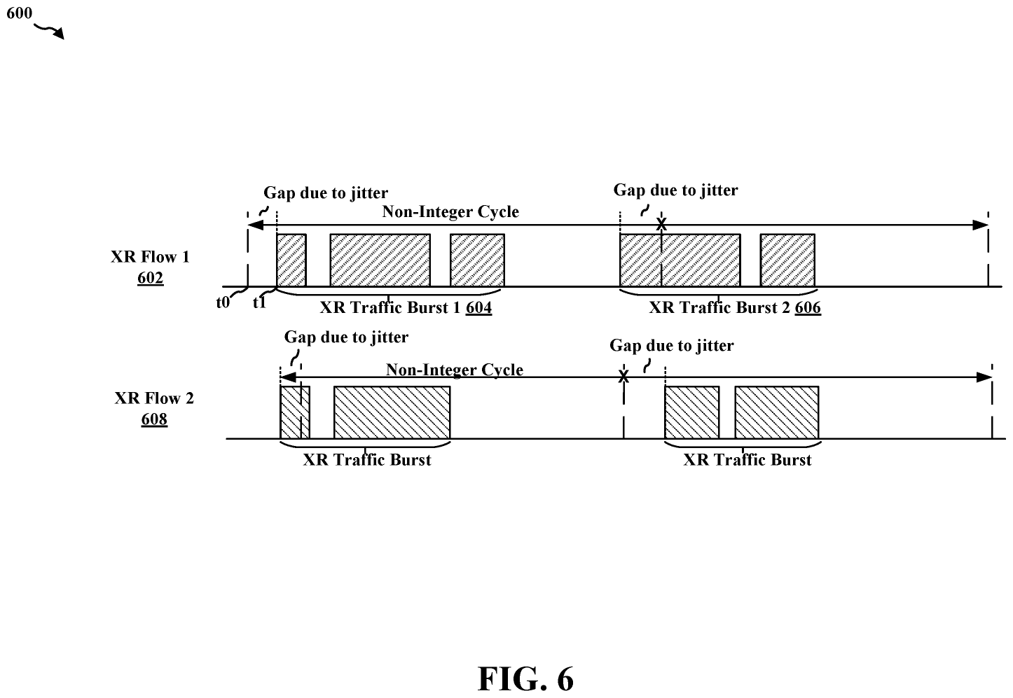

XR traffic may arrive in periodic traffic bursts (“XR traffic bursts” or “XR bursts”). An XR traffic burst may vary in a number of packets per burst and/or the size of each pack in the burst. The diagram 600 in FIG. 6 illustrates a first XR flow 602 that includes a first XR traffic burst 604 and a second XR traffic burst 606. As illustrated in the diagram 600, the traffic bursts may include different numbers of packets. For example, the first XR traffic burst 604 is shown with three packets (represented as rectangles in the diagram 600) and the second XR traffic burst 606 is shown with two packets. Furthermore, as illustrated in the diagram 600, the three packets in the first XR traffic burst 604 and the two packets in the second XR traffic burst 606 may vary in size. That is, packets within the first XR traffic burst 604 and the second XR traffic burst 606 may include varying amounts of data.

XR traffic bursts may arrive at non-integer periods (i.e., in a non-integer cycle). The periods may differ from an integer number of symbols, slots, etc. In one example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than the time at which a UE (or a base station) expects the XR traffic bursts. The variability of the packet arrival relative to the period (e.g., 16.76 ms period, 8.33 ms period, etc.) may be referred to as “jitter.” In one example, jitter for XR traffic may range from −4 ms (earlier than expected arrival) to +4 ms (later than expected arrival). For instance, referring to the first XR flow 602, a UE may expect a first packet of the first XR traffic burst 604 to arrive at time to, but the first packet of the first XR traffic burst 604 arrives at time t1.

XR traffic may include multiple flows that arrive at a UE (or a base station) concurrently with one another (or within a threshold period of time). For instance, the diagram 600 includes a second XR flow 608. The second XR flow 608 may have different characteristics than the first XR flow 602. For instance, the second XR flow 608 may have XR traffic bursts with different numbers of packets, different sizes of packets, etc. In one example, the first XR flow 602 may include video data, and the second XR flow 608 may include audio data for the video data. In another example, the first XR flow 602 may include intra-coded picture frames (I-frames) that include complete images, and the second XR flow 608 may include predicted picture frames (P-frames) that include changes from a previous image.

Example aspects presented herein provide methods and apparatus for the enhancements for the discard operations or processes based on the PDU set importance (PSI) in wireless communication. As used herein, the term “discard process,” which may also be referred to as “discard operation” or “discard procedure” in some aspects, refers to the process of dropping data packets, such as PDUs or SDUs, when certain conditions are met (e.g., when their delay exceeds a time threshold or during high network congestion). In some examples, the enhancements loosen the constraints on layer 2 (L2) parameter configuration so that the UE may more flexibly optimize the discard operations (e.g., based on AI/ML models or other mechanisms). In some examples, PSI-based discard processes (e.g., PDU discard) may be applied at the PDCP layer and in XR applications. In some examples, the UE may recommend, or indicate, various parameters to the network, or the UE may autonomously decide on various parameters, including PSI activation, PSI discard timer values, the amount of data to be discarded, or flow-level prioritization within DRB for discard. Based on the recommendation from the UE, the network may configure the DRBs to be UE activated or deactivated. In some examples, the UE may provide the recommendation or signal the autonomously selected values via UE assistance information (UAI), MAC-CE, uplink control information (UCI), or PDCP control PDU. In some examples, the UE may provide the recommendation or signal the autonomously selected values based on a trigger from the network. In some examples, the network may reconfigure the autonomously selected values from the UE. In some examples, the congestion levels may be provided to the UEs (e.g., in terms of buffer sizes) as assistance information for the discard operations. In some examples, the UE may record and report estimated congestion levels, PSI levels, PSI discard timer values, and delay statuses to the network to optimize the discard operations.

High-speed, low-latency, and high-reliability wireless communication enable latency-sensitive services, such as immersive extended reality (XR) multimedia applications, including augmented reality (AR) glasses, virtual reality (VR) head-mounted displays (HMD), cloud gaming, and cloud-based artificial intelligence (AI) services. These applications have strict performance criteria related to data rate, latency, and power consumption. For example, to ensure a seamless user experience in XR applications, 99% of XR packets should be delivered within a short packet delay budget (PDB), such as ten milliseconds (ms). The enhancements to the discard operations are provided to ensure these strict performance criteria are met, especially in the uplink.

In some examples, the discard operations (e.g., PDU discard processes) may be applied at the PDCP layer and may be based on the PDU set importance (PSI). The discard operations may be applicable to the PDU or service data unit (SDU) and may be referred to as PDU discard processes or SDU discard processes, respectively. As used herein, PDU set importance, or PSI may refer to the priority level assigned to a set of PDUs. The priority level of a PDU may affect the discard operations for the PDU. For example, a PDU with a higher PSI may be less likely to be discarded than a PDU with a lower PSI. In some examples, the PSI-based discard process may be based on a discard timer, such as a PDCP discard timer, and the PSI-based discard process may apply when the network is congested. For example, when a PDU has been buffered (e.g., stored) in the transmission buffer of a UE or a base station, a discard timer may start for that PDU. If the PDU has not been successfully transmitted within the discard timer's duration (e.g., due to network congestion), the discard condition is met, and the PDU may be discarded. For example, if the UE has buffered an uplink PDU longer than the discard timer's duration, the UE may discard (and not transmit) the PDU.

In some examples, the PSI-based discard process (e.g., PDU discard process) may be based on the implementation in the UE, which may determine the PSI levels that apply to the PSI-based PDU discard process during congested conditions. In some examples, the PDU sets categorized as low importance may be subject to PSI-based discard. In some examples, the network may configure two sets of PDCP discard timers for a data radio bearer (DRB) configured with PSI-based PDU discard. For example, one PDCP discard timer may be a regular discard timer, and the other PDCP discard timer may be a new timer used exclusively for PSI-based discard. For example, this new timer may be set to zero, enabling immediate discard of low-importance PDUs. In some examples, only one of these two PDCP discard timers may be active at any given time. In some examples, following a network activation, the UE may apply these discard timers for PSI-based PDU discard processes for low-importance PDU sets, ensuring that other running discard timers are not affected.

In some examples, the process of activating or deactivating the PSI-based PDU discard process may be signaled through a new MAC-CE. This indication may be specific to each DRB, enabling the independent and simultaneous control over multiple DRBs.

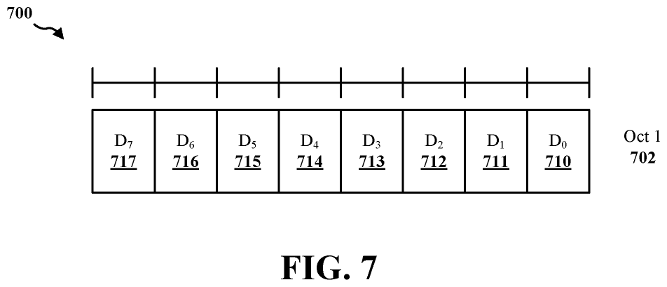

In some examples, the MAC-CE that activate or deactivate a PSI-based discard process (SDU discard process) may be identified by the MAC sub-header with a one-octet identifier (ID). FIG. 7 is a diagram 700 illustrating an example of a PSI-based discard activation/deactivation MAC-CE in accordance with various aspects of the present disclosure. As shown in FIG. 7, the one-octet ID may have a fixed size and may consist of one octet, such as Oct 1 702, as shown in FIG. 7. In FIG. 7, Dᵢ (e.g., D₀ 710, D₁ 711, D₂ 712, D₃ 713, D₄ 714, D₅ 715, D₆ 717, D₇ 717) may indicate the activation/deactivation status of the PSI-based discard process (e.g., SDU discard process) of DRB i, where i may be the ascending order of the DRB ID among the DRBs configured with a PSI-based discard process (e.g., SDU discard process). For example, the Dᵢ field set to 1 may indicate that the PSI-based discard process (e.g., SDU discard process) shall be activated for DRB i. The Dᵢ field set to 0 may indicate that the PSI-based discard process (e.g., SDU discard process) shall be deactivated for DRB i.

In some aspects, the network may activate a PSI-based discard process (e.g., SDU discard process) by sending the PSI-based discard activation/deactivation MAC-CE. In some examples, the PSI-based discard process (e.g., SDU discard process) may be initially deactivated upon a configuration or reconfiguration by upper layers. The activation or deactivation may have a per-DRB granularity. For example, the MAC entity may configure the PSI-based discard process (e.g., SDU discard process) for each DRB. If a PSI-based discard process (e.g., SDU discard process) activation or deactivation MAC-CE is received activating the PSI-based discard process (e.g., SDU discard process) for the DRB (e.g., for D₀ 710), the activation of the PSI-based discard process (e.g., SDU discard process) for the DRB (e.g., for D₀ 710) may be indicated to the upper layers. On the other hand, if a PSI-based discard process (e.g., SDU discard process) activation or deactivation MAC-CE is received deactivating the PSI-based discard process (e.g., SDU discard process) for the DRB (e.g., for D₁ 711), the deactivation of the PSI-based discard process (e.g., SDU discard process) for the DRB (e.g., for D₁ 711) may be indicated to the upper layers.

In some examples, for discard operations (e.g., uplink PDU discard processes) based on PSI, the activation or deactivation of a PDU set discard process may be through the MAC-CE signals on a per DRB basis (as opposed to per PSI level). In some examples, there may be two PSI levels (e.g., high and low) for PDU discard purposes. In some examples, when the MAC-CE activates the PDU set discard process based on PSI, the UE may discard the packets based on a PSI-based PDU discard timer.

Example aspects presented herein provide methods and apparatus for enhancing PSI-based discard operations (e.g., PDU or SDU discard processes). In some aspects, the methods and apparatus presented herein enable the UE to control the activation or deactivation or to provide the assistance information regarding which DRBs should be subject to a PSI-based discard process (e.g., SDU discard process). In some examples, the PSI-based discard indication may be provided at the DRB level, relying on the network's implementation to activate or deactivate which DRBs should apply the PSI-based PDU discard process based on MAC-CE signaling. However, as the network does not have direct knowledge of the UE's Layer 2 (L2) memory and application data buffers, which may be shared among various DRBs, allowing the UE to specify which DRBs are subject to the discard operations (e.g., PDU or SDU discard) provide more accurate control over the discard operations. In some aspects, the methods and apparatus presented herein enable the UE to specify multiple levels of PSI and to choose from multiple discard timers for the PSI-based discard operations according to the network conditions, which provide more comprehensive controls over the discard operations than the discard operations based on two levels of PSI and a single, static discard timer.

In some aspects, based on, for example, an AI/ML model implemented within or associated with the UE, the UE may perform discard operations (e.g., SDU discard) based on a PSI-based methodology that is controlled by the UE. For example, the AI/ML model may include any of the aspects described in connection with the ANN 400 or the ML architecture 500.

In some aspects, the UE may, based on certain rules or algorithms (e.g., AI/ML algorithms), recommend to the network or autonomously select a discard configuration related to discard operations (e.g., SDU discard processes) based on PSI. For example, the discard configuration may include one or more of the selection of data radio bearers (DRBs) for activation or deactivation for PSI-based discard, the UE's determination of one or more discard timers from the differentiated PSI discard timers to enable differentiated handling for PSI-based PDU set discard processes (e.g., UL PDU set discard processes). In some examples, the discard configuration may further include the identification of PSI levels within a DRB, which will be used by the UE to determine discard decisions. For example, some PSI levels (e.g., high-priority PSI levels) may be protected from any discard, so that the PDU set with these PSI levels will not be discarded.

In some aspects, the discard configuration may further include the amount of data to be discarded, associated with the PSI level that involved in PSI-based discard. In some aspects, the discard configuration may further include a flow level for the discard operations, which may be based on the PSI for each DRB in the set of DRBs. DRBs associated with different flows may be handled differently for the discard operations. For example, assuming that PSI categorization is done at the PDU set level and based on the importance of the frame (e.g., I-frame or P-frame), if a lower-priority flow (e.g., flow F1 with a PSI level of 2) is at the front of a higher-priority flow (e.g., flow F2 with a PSI level 1), the UE may more aggressively discard traffic associated with the lower-priority flow (e.g., flow F1) to ensure the higher-priority flow (e.g., flow F2) is preserved for uplink transmission. If there is no other higher priory traffic, the discard timer for the higher-priority flow (e.g., flow F2) may be set to more conservatively, making it less likely that the higher priority flow (e.g., flow F2) will be discarded.

In some aspects, the UE may provide recommendations to the network regarding the management of a PSI-based discard process (e.g., PSI-based SDU discard process). Based on the UE's recommendations, the network may configure which DRBs can be activated or deactivated for PSI-based discard operations. In some aspects, the UE may recommend the PSI discard timers to the network, enhancing the network's ability to manage the discard processes more efficiently. In some examples, the recommendation for the DRB activation/deactivation and the recommendation for the discard timers may be sent in separate reports. In some examples, the recommendation for the DRB activation/deactivation and the recommendation for the discard timers may be sent in a single report. In some examples, the recommendations may be communicated through various channels such as UE assistance information (UAI), medium access control (MAC)-control element (MAC-CE), uplink control information (UCI), or in response to triggers from the network.

In some aspects, the UE may signal its preferences for PSI-based discard timers (e.g., SDU discard timers) to the network in, for example, assistance information. Based on the UE's signaling, the network may reconfigure the PSI timers and identify which DRBs are subject to these timers. The signaling of these preferences can be accomplished through mechanisms like UAI, MAC-CE, or packet data convergence protocol (PDCP) control PDU. In some examples, the UE may signal its preferences for PSI-based discard timers in response to the changes in network conditions, for example. In some examples, the UE may signal preference periodically based on a periodicity. In some examples, the network may configure the frequency of the UE's reporting (e.g., the periodicity for the UE's reporting).

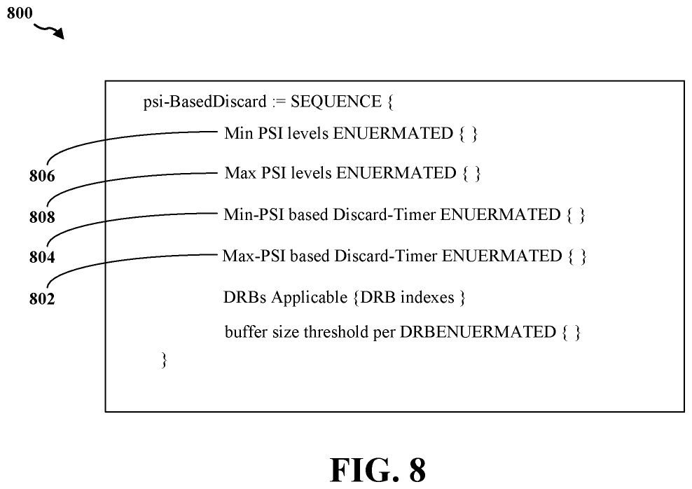

In some aspects, the network may configure various parameters related to the PSI-based discard operations. FIG. 8 is a diagram 800 illustrating an example information element (IE) for controlling the PSI-based discard operations in accordance with various aspects of the present disclosure. As shown in FIG. 8, the network may configure the bounds of the PSI-based discard timer (e.g., PSI-based PDU discard timer). For example, the network may set the maximum and minimum values of the PSI PDU discard timer (e.g., Max-PSI based Discard-Timer 802, Min-PSI based Discard-Timer 804). In some examples, the network may set the maximum and minimum values of PSI levels (e.g., Min PSI levels 806, Max PSI levels 808), and the total number of PSI levels that can be utilized. In some examples, the parameters related to the PSI-based discard process (e.g., the maximum and minimum values of the PSI PDU discard timers) may be dynamically adjusted based on key performance indicators (KPIs) or variations in network congestion levels.

In some aspects, the UE may recommend to the network or autonomously select the discard configuration when a trigger condition has been met. The trigger condition may include scenarios such as an increase in the number of discarded in uplink PDUs, the change in the granularity of the PSI level, the change in the estimated throughput, or the change in the bandwidth between the UE and the network.

In some aspects, the network may configure the UE to adjust the operation of AI/ML functionalities, depending on certain trigger events. For example, the network may transmit a functionality configuration for the UE. The functionality configuration may indicate the activation of the AI/ML model, the inactivation of the AI/ML model, or a fallback or switch to the AI/ML model from another AI/ML model. This adjustment can take various forms, such as activating, deactivating, switching, or falling back to different operational modes of the AI/ML feature. For example, the AI/ML model may include any of the aspects described in connection with the ANN 400 or the ML architecture 500.

The trigger events for these adjustments may include scenarios such as an estimated change in available bandwidth between the UE and the network, the change in the congestion level between the UE and the network, the deterioration in the link quality associated with the UE, or an increase in the demand for transmission resources. Additionally, trigger events may include the increase in the uplink delay, which may be indicated in the delay status report, or the number of discards being above a discard threshold. In some examples, some of these metrics (which are related to the trigger events that influence the AI/ML functionalities' operation) may be estimated and controlled by the network and may be provided to the UE.

In some examples, the UE may signal to the network through, for example, an uplink MAC-CE, indicating its preference for the activation or deactivation of certain DRBs for its AI-controlled PSI-based discard operations (e.g., SDU discard operations).

In some aspects, the UE may continuously record discard records and report the discard records to the network over time. This process may enable a dynamic adjustment of the discard configuration, such as the discard timer settings and the activation status of individual DRBs, based on real-time network conditions, such as the network congestion level. The discard records may include metrics related to the discard operations. These matrices may include, for example, one or more of: the estimated congestion level between the UE and the network entity, the network-indicated congestion level between the UE and the network entity, the PSI level corresponding to the estimated congestion level or the network-indicated congestion level, the PSI discard timer values, the delay status associated with the UE, the discard status associated with the UE, the buffer size for each DRB of the set of DRBs, or the buffer size limit for each PSI level of a set of PSI levels.

In some examples, the network congestion level may be related to the available bandwidth and may be more accurately estimated at the network side. In some examples, the congestion level may be provided to the UE in terms of buffer size.

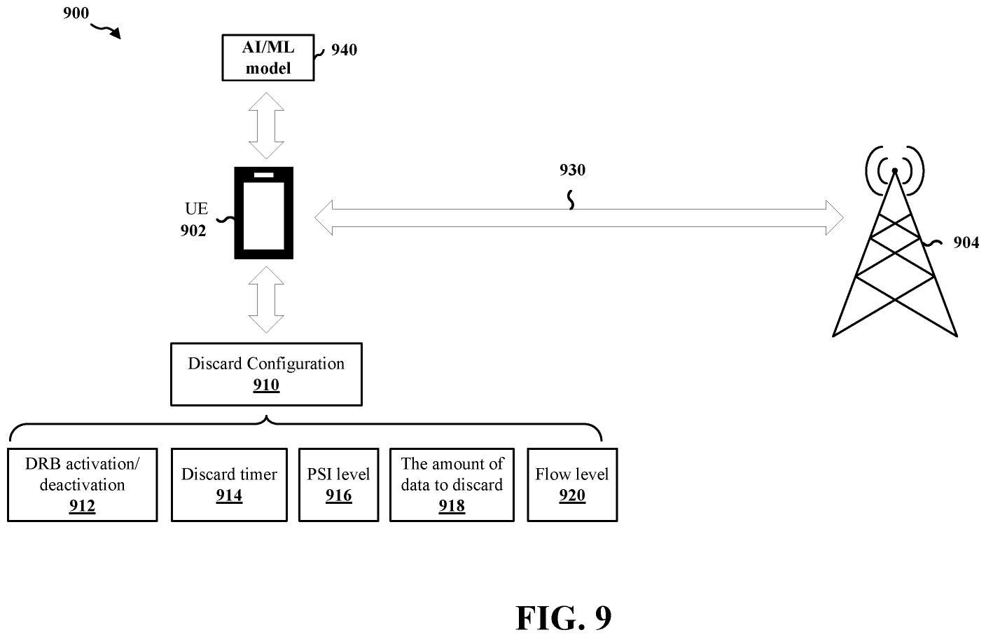

FIG. 9 is a diagram 900 illustrating an example PSI-based discard operation in accordance with various aspects of the present disclosure. In FIG. 9, the UE 902 may determine a discard configuration 910 for communication 930 with the base station 1004. The discard configuration 910 may include the activation or deactivation status for each DRB in a set of DRBs (e.g., 912), a selection of the discard timers from a set of discard timers (e.g., at 914), and a PSI level from a set of PSI levels (e.g., at 916). In some examples, the discard configuration 910 may further include the amount of data to discard for each PSI level of the set of PSI levels (e.g., at 918) and the flow level for the discard process for each DRB in the set of DRBs (e.g., at 920). In some examples, the UE 902 may determine the discard configuration 910 based on an AI/ML model 940 that is included in or associated with the UE 902. In some examples, the AI/ML model 940 may include any of the aspects described in connection with the ANN 400 or the ML architecture 500.

In some examples, the UE 902 and the base station 904 may exchange information related to the discard configuration. For example, the base station 904 may send a network request for the UE 902 for the UE's preferred discard configuration, and the UE 902 may transmit the discard configuration 910 as its preferred discard configuration to the base station 904. In some examples, the UE 902 may transmit the discard configuration 910 to the base station 904 via UAI, MAC-CE, UCI, or a trigger from the base station 904. For example, the UE 902 may indicate which DRBs to be activated or deactivated for a PSI-based discard process via a MAC-CE described in connection with FIG. 7. In some examples, the base station 904 may reconfigure the discard configuration 910 received from the UE 902 for the discard operations. For example, the base station 904 may reconfigure the discard timer (e.g., 914) and activation or deactivation status of the DRBs (e.g., 912). In some examples, the base station 904 may transmit a functionality configuration related to the AI/ML model 940. For example, the functionality configuration may indicate the activation of the AI/ML model 940, the deactivation of the AI/ML model 940, or a fallback or switch to the AI/ML model 940 from another AI/ML model.

In some examples, the discard configuration 910 may be determined based on a change in the network condition. For example, the change in the network condition may include one or more of: the increase in the number of discards in uplink PDU, the change in a granularity of an PSI level, the change in an estimated throughput, or the change in the bandwidth between the UE and the network entity.

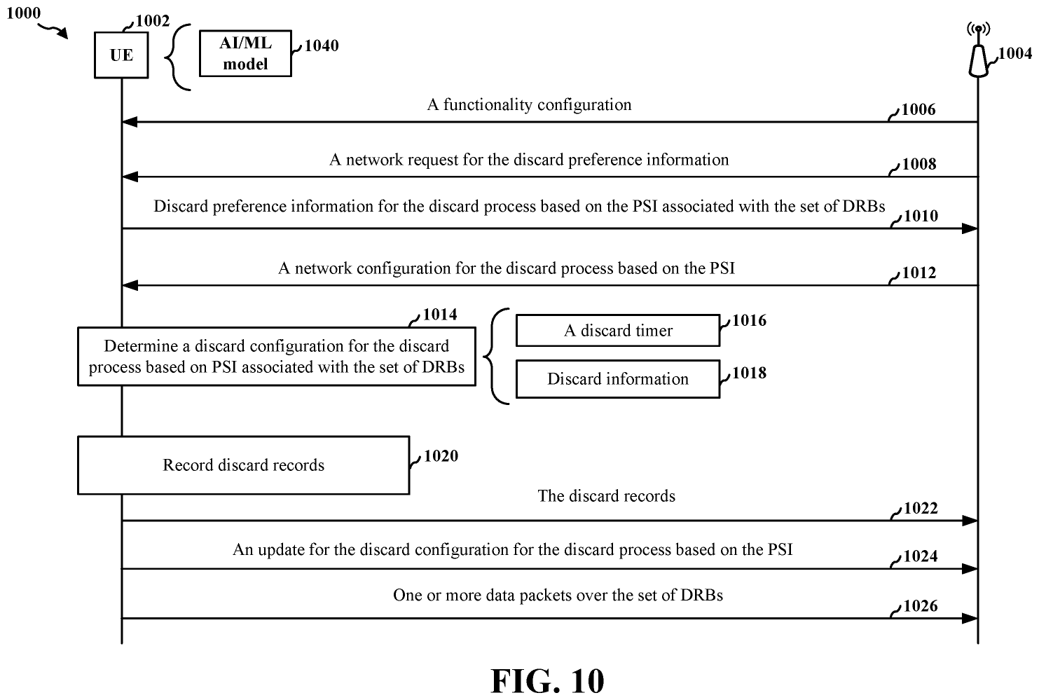

FIG. 10 is a call flow diagram 1000 illustrating a method of wireless communication in accordance with various aspects of this present disclosure. Various aspects are described in connection with a UE 1002 and a base station 1004. The aspects may be performed by the UE 1002 or the base station 1004 in aggregation and/or by one or more components of a base station 1004 (e.g., a CU 110, a DU 130, and/or an RU 140).

As shown in FIG. 10, a UE 1002 may receive a functionality configuration from the base station 1004. The functionality configuration may indicate an AI/ML model for the UE 1002. For example, the functionality configuration may indicate the activation of the AI/ML model 1040, an inactivation of the AI/ML model 1040, or a fallback or switch to the AI/ML model 1040 from another AI/ML model. In some examples, the base station 1004 may send the functionality configuration based on a trigger event related to the network condition. For example, the trigger event may include one or more of: the change in the available bandwidth between the UE 1002 and the base station 1004, the change in a congestion level between the UE 1002 and the base station 1004, the degradation in the link quality, the increase in the demand for transmission resources, the increase in the uplink delay, or the number of discards greater than a discard threshold.

In some examples, at 1008, the UE 1002 may receive a network request for the discard preference information.

In some examples, at 1010, the UE 1002 may provide for the base station 1004 the discard preference information for the discard process based on the PSI associated with the set of DRBs. For example, the UE 1002 may provide the discard preference information for the base station 1004 via one of: UAI, MAC-CE, UCI, or PDCP control PDU. In some examples, the discard preference information may include discard timer information for the discard process based on the PSI.

At 1012, the UE 1002 may receive a network configuration for the discard process based on the PSI from the base station 1004. In some examples, the network configuration may be based on the discard preference the UE 1002 provided for the base station 1004 at 1010. In some examples, the network configuration may include a timer configuration for the discard timer used for each DRB in the set of DRBs, and the timer configuration may be based on the discard timer information included in the discard preference information.

At 1014, the UE 1002 may determine a discard configuration for the discard process based on PSI associated with the set of DRBs. For example, the discard configuration may include a discard timer 1016 and discard information 1018 for each DRB in the set of DRBs. In some examples, the discard information 1018 may further include the amount of data to discard (e.g., at 918) for each PSI level of multiple PSI levels and the flow level (e.g., at 920) for the discard process based on the PSI for each DRB in the set of DRBs.

At 1020, the UE 1002 may record the discard records. The discard records may include information related to the discard configuration applied on various network conditions. For examples, the discard records may include one or more of: the congestion level between the UE 1002 and the base station 1004 (which may be estimated by the UE 1002 or indicated by the base station 1004), the PSI level corresponding to the congestion level, the PSI discard timer values, the delay status associated with the UE, the discard status associated with the UE, the buffer size for each DRB of the set of DRBs, or the buffer size limit for each PSI level of a set of PSI levels.

At 1022, the UE 1002 may transmit the discard records to the base station 1004. These information may enable a dynamic adjustment of the discard configuration, such as the discard timer settings and the activation status of individual DRBs, based on real-time network conditions, such as the network congestion level.

At 1024, if there are changes to the discard configuration (e.g., due to changed congestion level), the UE 1002 may transmit to the base station 1004 an update for the discard configuration for the discard process based on the PSI.

At 1026, the UE 1002 may transmit one or more data packets to the base station 1004 based on the discard configuration (which the UE 1002 determined at 1014).

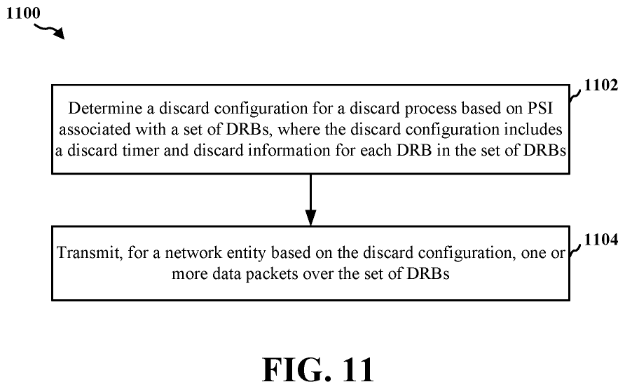

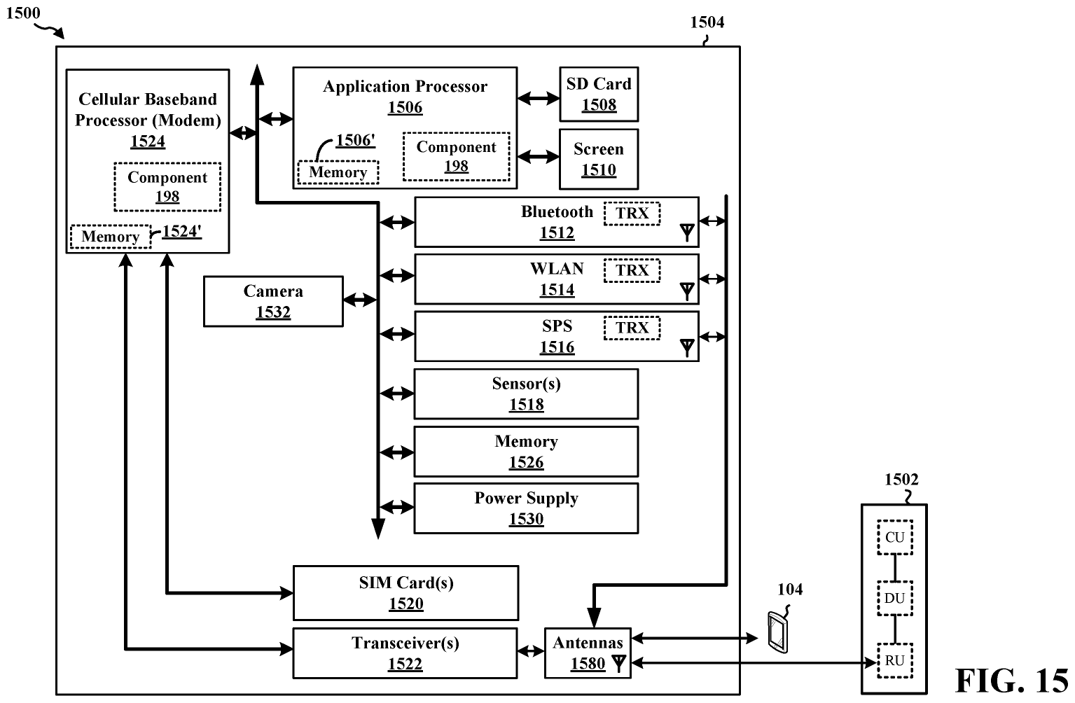

FIG. 11 is a flowchart 1100 illustrating methods of wireless communication at a UE in accordance with various aspects of the present disclosure. The method may be performed by a UE. The UE may be the UE 104, 350, 902, 1002, or the apparatus 1504 in the hardware implementation of FIG. 15. The methods enable the UE to recommend or autonomously select DRBs for activation or deactivation of PSI-based discard, thereby conserving bandwidth and enabling more efficient use of transmission resources. Additionally, the methods provide differentiated PSI levels and PSI discard timers for discard purposes to ensure that high-priority data is transmitted efficiently, thereby enhancing the user experience in latency-sensitive applications, such as XR applications. By leveraging AI/ML models to determine the discard configuration, the methods enable the UE to adjust the discard configurations based on real-time network c conditions autonomously, ensuring wireless communication quality under various network congestion levels and bandwidth availability conditions.

As shown in FIG. 11, at 1102, the UE may determine a discard configuration for a discard process based on PSI associated with a set of DRBs. The discard configuration may include a discard timer and discard information for each DRB in the set of DRBs. FIG. 7, FIG. 8, FIG. 9, and FIG. 10 illustrate various aspects of the steps in connection with flowchart 1100. For example, referring to FIG. 10, the UE 1002 may determine, at 1014, a discard configuration for a discard process based on PSI associated with the set of DRBs. The discard configuration includes a discard timer 1016 and discard information 1018 for each DRB in the set of DRBs. Referring to FIG. 9, the UE 902 may determine the discard configuration 910, which may include a discard timer 914 and discard information (e.g., 912, 916, 918, and 920) for each DRB in the set of DRBs. In some examples, 1102 may be performed by the PDU discard component 198.

At 1104, the UE may transmit, for a network entity, based on the discard configuration, one or more data packets over the set of DRBs. The network entity may be a base station, or a component of a base station, in the access network of FIG. 1 or a core network component (e.g., base station 102, 310, 904, 1004; or the network entity 1502 in the hardware implementation of FIG. 15). For example, referring to FIG. 10, the UE 1002 may transmit, at 1026, for a network entity (base station 1004), based on the discard configuration, one or more data packets over the set of DRBs. In some examples, 1104 may be performed by the PDU discard component 198.

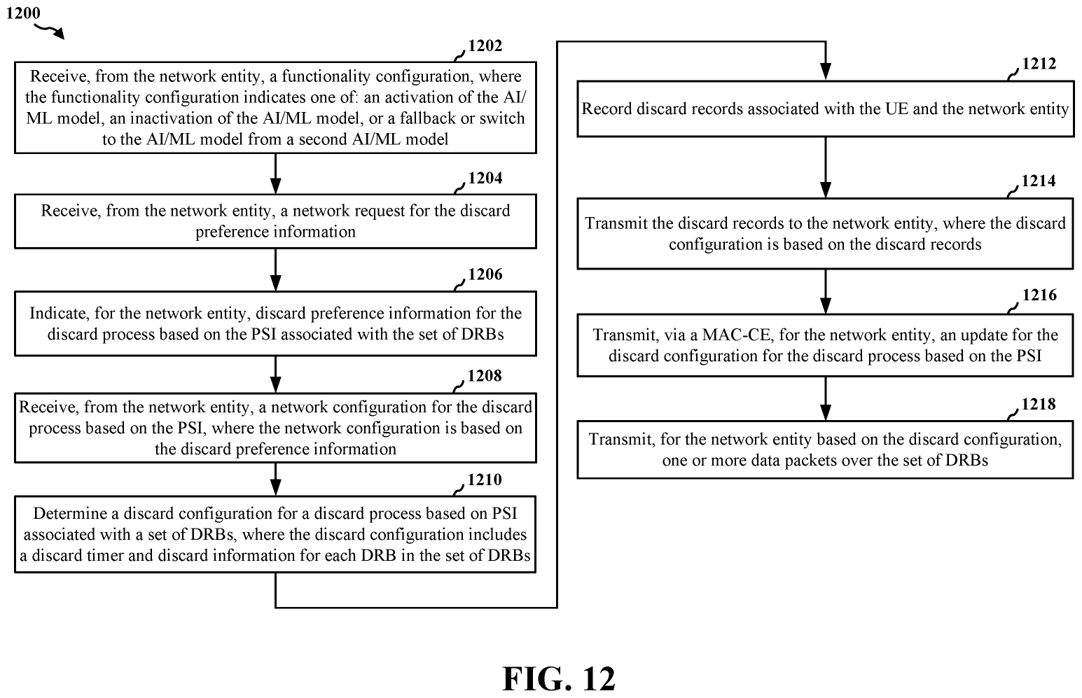

FIG. 12 is a flowchart 1200 illustrating methods of wireless communication at a UE in accordance with various aspects of the present disclosure. The method may be performed by a UE. The UE may be the UE 104, 350, 902, 1002, or the apparatus 1504 in the hardware implementation of FIG. 15. The methods enable the UE to recommend or autonomously select DRBs for activation or deactivation of PSI-based discard, thereby conserving bandwidth and enabling more efficient use of transmission resources. Additionally, the methods provide differentiated PSI levels and PSI discard timers for discard purposes to ensure that high-priority data is transmitted efficiently, thereby enhancing the user experience in latency-sensitive applications, such as XR applications. By leveraging AI/ML models to determine the discard configuration, the methods enable the UE to adjust the discard configurations based on real-time network conditions autonomously, ensuring wireless communication quality under various network congestion levels and bandwidth availability conditions.

As shown in FIG. 12, at 1210, the UE may determine a discard configuration for a discard process based on PSI associated with a set of DRBs. The discard configuration may include a discard timer and discard information for each DRB in the set of DRBs. FIG. 7, FIG. 8, FIG. 9, and FIG. 10 illustrate various aspects of the steps in connection with flowchart 1200. For example, referring to FIG. 10, the UE 1002 may determine, at 1014, a discard configuration for a discard process based on PSI associated with the set of DRBs. The discard configuration includes a discard timer 1016 and discard information 1018 for each DRB in the set of DRBs. Referring to FIG. 9, the UE 902 may determine the discard configuration 910, which may include a discard timer 914 and discard information (e.g., 912, 916, 918, and 920) for each DRB in the set of DRBs. In some examples, 1210 may be performed by the PDU discard component 198.

At 1218, the UE may transmit, for a network entity, based on the discard configuration, one or more data packets over the set of DRBs. The network entity may be a base station, or a component of a base station, in the access network of FIG. 1 or a core network component (e.g., base station 102, 310, 904, 1004; or the network entity 1502 in the hardware implementation of FIG. 15). For example, referring to FIG. 10, the UE 1002 may transmit, at 1026, for a network entity (base station 1004), based on the discard configuration, one or more data packets over the set of DRBs. In some examples, 1214 may be performed by the PDU discard component 198.

In some aspects, the discard information for each DRB in the set of DRBs may include one or more of: an activation or deactivation status for each DRB in the set of DRBs for the discard process based on the PSI, or one PSI level from multiple PSI levels for the discard process based on the PSI for each DRB in the set of DRBs. For example, referring to FIG. 9, the discard information for each DRB in the set of DRBs may include one or more of: an activation or deactivation status for each DRB in the set of DRBs (e.g., at 912) for the discard process based on the PSI, or one PSI level from multiple PSI levels (e.g., at 916) for the discard process based on the PSI for each DRB in the set of DRBs.

In some aspects, the discard configuration may further include the amount of data to discard for each PSI level of the multiple PSI levels. For example, referring to FIG. 9, the discard configuration 910 may further include the amount of data to discard (e.g., 918) for each PSI level of the multiple PSI levels.

In some aspects, the discard configuration may further include a flow level for the discard process based on the PSI for each DRB in the set of DRBs. For example, referring to FIG. 9, the discard configuration 910 may further include a flow level for the discard process (e.g., 920) based on the PSI for each DRB in the set of DRBs.

In some aspects, to determine the discard configuration (at 1214), the UE may determine the discard configuration based on an AI/ML model. For example, referring to FIG. 10, the UE 1002 may determine, at 1014, the discard configuration based on an AI/ML model 1040. Referring to FIG. 9, the UE 902 may determine the discard configuration 910 based on an AI/ML model 940. For example, the AI/ML model (e.g., 940, 1040) may include any of the aspects described in connection with the ANN 400 or the ML architecture 500.

In some aspects, at 1202, the UE may receive, from the network entity, a functionality configuration. The functionality configuration indicates one of: an activation of the AI/ML model, an inactivation of the AI/ML model, or a fallback or switch to the AI/ML model from a second AI/ML model. For example, referring to FIG. 10, the UE 1002 may receive, at 1006, from the network entity (base station 1004), a functionality configuration. The functionality configuration indicates one of: an activation of the AI/ML model 1040, an inactivation of the AI/ML model 1040, or a fallback or switch to the AI/ML model 1040 from a second AI/ML model. In some examples, 1202 may be performed by the PDU discard component 198.

In some aspects, the functionality configuration may be based on a trigger event. The trigger event may include one or more of: a first change in an available bandwidth between the UE and the network entity, a second change in a congestion level between the UE and the network entity, a degradation in a link quality associated with the UE, a first increase in a demand for transmission resources, a second increase in an uplink delay, or a number of discards greater than a discard threshold. For example, referring to FIG. 10, the functionality configuration (at 1006) may be based on a trigger event. The trigger event may include one or more of: a first change in an available bandwidth between the UE 1002 and the network entity (base station 1004), a second change in a congestion level between the UE 1002 and the network entity (base station 1004), a degradation in a link quality associated with the UE 1002, a first increase in a demand for transmission resources, a second increase in an uplink delay, or a number of discards greater than a discard threshold.

In some aspects, at 1206, the UE may indicate, for the network entity, discard preference information for the discard process based on the PSI associated with the set of DRBs. At 1208, the UE may receive, from the network entity, a network configuration for the discard process based on the PSI. The network configuration may be based on the discard preference information. For example, referring to FIG. 10, the UE 1002 may indicate, at 1010, for the network entity (base station 1004), discard preference information for the discard process based on the PSI associated with the set of DRBs. At 1012, the UE 1002 may receive, from the network entity (base station 1004), a network configuration for the discard process based on the PSI. In some examples, 1206 and 1208 may be performed by the PDU discard component 198.

In some aspects, to determine the discard configuration (at 1210), the UE may determine the discard configuration based on the network configuration. For example, referring to FIG. 10, the UE 1002 may, at 1014, determine the discard configuration based on the network configuration received at 1012.

In some aspects, the UE may indicate the discard preference information (at 1206) via one or more of: UAI, a MAC-CE, UCI, or a PDCP control PDU. For example, referring to FIG. 10, the UE 1002 may, at 1010, indicate the discard preference information via one or more of: UAI, a MAC-CE, UCI, or a PDCP control PDU to the base station 1004.

In some aspects, at 1204, the UE may receive, from the network entity, a network request for the discard preference information. In some aspects, the UE may indicate the discard preference information (at 1206) in response to the network request. For example, referring to FIG. 10, the UE 1002 may, at 1008, receive, from the network entity (base station 1004), a network request for the discard preference information, and the UE 1002 may, at 1010, indicate the discard preference information in response to the network request. In some examples, 1204 may be performed by the PDU discard component 198.

In some aspects, the network configuration (at 1208) may include a timer configuration for the discard timer for each DRB in the set of DRBs, and the discard timer included in the discard configuration may be based on the timer configuration. For example, referring to FIG. 10, the network configuration (at 1012) may include a timer configuration for the discard timer for each DRB in the set of DRBs, and the discard timer 1016 included in the discard configuration (at 1014) may be based on the timer configuration.

In some aspects, the discard preference information (at 1206) may include discard timer information for the discard process based on the PSI, and the timer configuration may be based on the discard timer information. For example, referring to FIG. 10, the discard preference information (at 1010) may include discard timer information for the discard process based on the PSI, and the timer configuration may be based on the discard timer information.

In some aspects, the UE may indicate the discard preference information (at 1206) periodically based on a periodicity. For example, referring to FIG. 10, the UE 1002 may indicate, at 1010, the discard preference information periodically based on a periodicity.

In some aspects, the timer configuration may include one or more of: the minimum value of the discard timer, or the maximum value of the discard timer. For example, referring to FIG. 8, the timer configuration may include one or more of: the minimum value of the discard timer (e.g., at 804) or the maximum value of the discard timer (e.g., at 802).

In some aspects, the network configuration may further include one or more of: the minimum value for each PSI level of the multiple PSI levels, or the maximum value for each PSI level of the multiple PSI levels. For example, referring to FIG. 10, the network configuration (at 1012) may further include one or more of: the minimum value for each PSI level of the multiple PSI levels, or the maximum value for each PSI level of the multiple PSI levels. For example, referring to FIG. 8, the network configuration may further include one or more of: the minimum value for each PSI level of the multiple PSI levels (e.g., at 806) or the maximum value for each PSI level of the multiple PSI levels (e.g., at 808).

In some aspects, the network configuration may be based on one or more of: a key performance indicator (KPI), or the change in a congestion level between the network entity and the UE. For example, referring to FIG. 10, the network configuration (at 1012) may be based on one or more of: a key performance indicator (KPI), or the change in a congestion level between the network entity (base station 1004) and the UE 1002.

In some aspects, the UE may determine the discard configuration (at 1210) in response to a trigger condition being met, and the trigger condition may include one or more of: the increase in a number of discards in uplink PDU, a first change in a granularity of an PSI level, a second change in an estimated throughput, or a third change in a bandwidth between the UE and the network entity. For example, referring to FIG. 10, the UE 1002 may determine the discard configuration (at 1014) in response to a trigger condition being met. The trigger condition may include one or more of: the increase in a number of discards in uplink PDU, a first change in a granularity of an PSI level, a second change in an estimated throughput, or a third change in a bandwidth between the UE 1002 and the network entity (base station 1004).

In some aspects, at 1216, the UE may transmit, via a MAC-CE, for the network entity, an update for the discard configuration for the discard process based on the PSI. For example, referring to FIG. 10, the UE 1002 may transmit, at 1024, via a MAC-CE, for the network entity (base station 1004), an update for the discard configuration for the discard process based on the PSI. In some examples, 1216 may be performed by the PDU discard component 198.

In some aspects, at 1212, the UE may record discard records associated with the UE and the network entity. At 1214, the UE may transmit the discard records to the network entity. The discard configuration (at 1210) may be based on the discard records, and the discard records may include one or more of: an estimated congestion level between the UE and the network entity, a network-indicated congestion level between the UE and the network entity, a PSI level corresponding to the estimated congestion level or the network-indicated congestion level, PSI discard timer values, a delay status associated with the UE, a discard status associated with the UE, a buffer size for each DRB of the set of DRBs, or a buffer size limit for each PSI level of a set of PSI levels. For example, referring to FIG. 10, the UE 1002 may record, at 1020, discard records associated with the UE 1002 and the network entity (base station 1004). At 1022, the UE 1002 may transmit the discard records to the network entity (base station 1004). The discard configuration (at 1014) may be based on the discard records, and the discard records may include one or more of: an estimated congestion level between the UE 1002 and the network entity (base station 1004), a network-indicated congestion level between the UE 1002 and the network entity (base station 1004), a PSI level corresponding to the estimated congestion level or the network-indicated congestion level, PSI discard timer values, a delay status associated with the UE 1002, a discard status associated with the UE 1002, a buffer size for each DRB of the set of DRBs, or a buffer size limit for each PSI level of a set of PSI levels. In some examples, 1210 and 1212 may be performed by the PDU discard component 198.

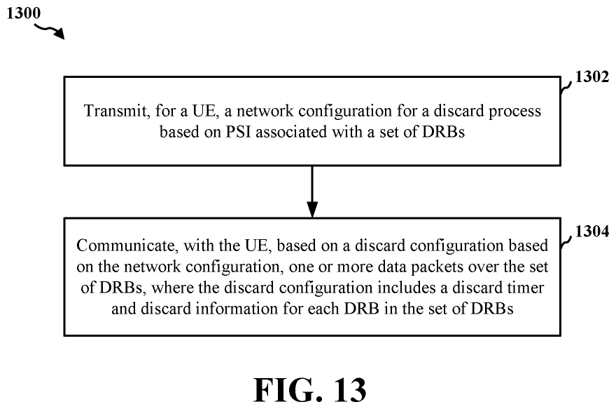

FIG. 13 is a flowchart 1300 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 904, 1004; or the network entity 1502 in the hardware implementation of FIG. 15). The methods enable the UE to recommend or autonomously select DRBs for activation or deactivation of PSI-based discard, thereby conserving bandwidth and enabling more efficient use of transmission resources. Additionally, the methods provide differentiated PSI levels and PSI discard timers for discard purposes to ensure that high-priority data is transmitted efficiently, thereby enhancing the user experience in latency-sensitive applications, such as XR applications. By leveraging AI/ML models to determine the discard configuration, the methods enable the UE to adjust the discard configurations based on real-time network conditions autonomously, ensuring wireless communication quality under various network congestion levels and bandwidth availability conditions.

As shown in FIG. 13, at 1302, the network entity may transmit, for a UE, a network configuration for a discard process based on PSI associated with a set of DRBs. The UE may be the UE 104, 350, 902, 1002, or the apparatus 1504 in the hardware implementation of FIG. 15. FIG. 7, FIG. 8, FIG. 9, and FIG. 10 illustrate various aspects of the steps in connection with flowchart 1300. For example, referring to FIG. 10, the network entity (base station 1004) may transmit, at 1012, for a UE 1002, a network configuration for a discard process based on PSI associated with a set of DRBs. In some examples, 1302 may be performed by the PDU discard component 199.

At 1304, the network entity may communicate, with the UE based on a discard configuration based on the network configuration, one or more data packets over the set of DRBs. The discard configuration may include a discard timer and discard information for each DRB in the set of DRBs. For example, referring to FIG. 10, the network entity (base station 1004) may communicate, at 1026, with the UE 1002 based on a discard configuration (at 1014) based on the network configuration, one or more data packets over the set of DRBs. Referring to FIG. 9, the discard configuration 910 may include a discard timer 914 and discard information (e.g., 912, 916, 918, 920) for each DRB in the set of DRBs. In some examples, 1304 may be performed by the PDU discard component 199.

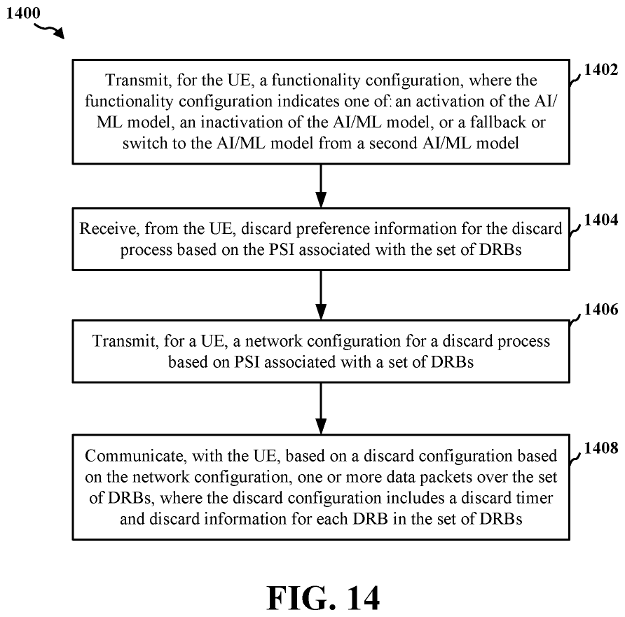

FIG. 14 is a flowchart 1400 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 904, 1004; or the network entity 1502 in the hardware implementation of FIG. 15). The methods enable the UE to recommend or autonomously select DRBs for activation or deactivation of PSI-based discard, thereby conserving bandwidth and enabling more efficient use of transmission resources. Additionally, the methods provide differentiated PSI levels and PSI discard timers for discard purposes to ensure that high-priority data is transmitted efficiently, thereby enhancing the user experience in latency-sensitive applications, such as XR applications. By leveraging AI/ML models to determine the discard configuration, the methods enable the UE to adjust the discard configurations based on real-time network conditions autonomously, ensuring wireless communication quality under various network congestion levels and bandwidth availability conditions.

As shown in FIG. 14, at 1406, the network entity may transmit, for a UE, a network configuration for a discard process based on PSI associated with a set of DRBs. The UE may be the UE 104, 350, 902, 1002, or the apparatus 1504 in the hardware implementation of FIG. 15. FIG. 7, FIG. 8, FIG. 9, and FIG. 10 illustrate various aspects of the steps in connection with flowchart 1400. For example, referring to FIG. 10, the network entity (base station 1004) may transmit, at 1012, for a UE 1002, a network configuration for a discard process based on PSI associated with a set of DRBs. In some examples, 1406 may be performed by the PDU discard component 199.

At 1408, the network entity may communicate, with the UE based on a discard configuration based on the network configuration, one or more data packets over the set of DRBs. The discard configuration may include a discard timer and discard information for each DRB in the set of DRBs. For example, referring to FIG. 10, the network entity (base station 1004) may communicate, at 1026, with the UE 1002 based on a discard configuration (at 1014) based on the network configuration, one or more data packets over the set of DRBs. Referring to FIG. 9, the discard configuration 910 may include a discard timer 914 and discard information (e.g., 912, 916, 918, 920) for each DRB in the set of DRBs. In some examples, 1408 may be performed by the PDU discard component 199.

In some aspects, at 1404, the network entity may receive, from the UE, discard preference information for the discard process based on the PSI associated with the set of DRBs. The network configuration (at 1406) may be based on the discard preference information. For example, referring to FIG. 10, the network entity (base station 1004) may receive, at 1010, from the UE 1002, discard preference information for the discard process based on the PSI associated with the set of DRBs. The network configuration (at 1012) may be based on the discard preference information. In some examples, 1404 may be performed by the PDU discard component 199.

In some aspects, the discard information for each DRB in the set of DRBs may include one or more of: an activation or deactivation status for each DRB in the set of DRBs for the discard process based on the PSI, or one PSI level from multiple PSI levels for the discard process based on the PSI for each DRB in the set of DRBs. For example, referring to FIG. 7, the discard information for each DRB in the set of DRBs may include one or more of: an activation or deactivation status for each DRB in the set of DRBs (e.g., via the values of D₀ 710, D₁ 711, D₂ 712, D₃ 713, D₄ 714, D₅ 715, D₆ 716, D₇ 717) for the discard process based on the PSI, or one PSI level from multiple PSI levels for the discard process based on the PSI for each DRB in the set of DRBs.

In some aspects, the discard configuration may further include one or more of: an amount of data to discard for each PSI level of the multiple PSI levels, or a flow level for the discard process based on the PSI for each DRB in the set of DRBs. For example, referring to FIG. 9, the discard configuration 910 may further include one or more of: an amount of data to discard (e.g., at 918) for each PSI level of the multiple PSI levels, or a flow level (e.g., at 920) for the discard process based on the PSI for each DRB in the set of DRBs.

In some aspects, the discard configuration may be based on an AI/ML model. For example, referring to FIG. 10, the discard configuration (at 1014) may be based on the AI/ML model 1040. Referring to FIG. 9, the discard configuration 910 may be based on the AI/ML model 940.

In some aspects, at 1402, the network entity may transmit, for the UE, a functionality configuration. The functionality configuration may indicate one of: an activation of the AI/ML model, an inactivation of the AI/ML model, or a fallback or switch to the AI/ML model from a second AI/ML model. For example, referring to FIG. 10, the network entity (base station 1004) may transmit, at 1006, for the UE 1002, a functionality configuration. The functionality configuration may indicate one of: an activation of the AI/ML model 1040, an inactivation of the AI/ML model 1040, or a fallback or switch to the AI/ML model 1040 from a second AI/ML model. In some examples, 1402 may be performed by the PDU discard component 199.

In some aspects, the network entity may transmit the functionality configuration (at 1402) based on a trigger event, and the trigger event may include one or more of: a first change in an available bandwidth between the UE and the network entity, a second change in a congestion level between the UE and the network entity, a degradation in a link quality associated with the UE, a first increase in a demand for transmission resources, a second increase in an uplink delay, or a number of discards greater than a discard threshold. For example, referring to FIG. 10, the network entity (base station 1004) may transmit the functionality configuration (at 1006) based on a trigger event, and the trigger event may include one or more of: a first change in an available bandwidth between the UE 1002 and the network entity (base station 1004), a second change in a congestion level between the UE 1002 and the network entity (base station 1004), a degradation in a link quality associated with the UE 1002, a first increase in a demand for transmission resources, a second increase in an uplink delay, or a number of discards greater than a discard threshold.

In some aspects, the network configuration (at 1406) may include a timer configuration for the discard timer for each DRB in the set of DRBs, and the discard timer included in the discard configuration may be based on the timer configuration. For example, referring to FIG. 10, the network configuration (at 1012) may include a timer configuration for the discard timer for each DRB in the set of DRBs, and the discard timer included in the discard configuration (at 1014) may be based on the timer configuration.

In some aspects, the timer configuration may include one or more of: the minimum value of the discard timer, or the maximum value of the discard timer. The network configuration (at 1406) may further include one or more of: the minimum value for each PSI level of the multiple PSI levels, or the maximum value for each PSI level of the multiple PSI levels. For example, referring to FIG. 8, the timer configuration may include one or more of: the minimum value of the discard timer (e.g., at 804), or the maximum value of the discard timer (e.g., at 802). The network configuration (at 1012) may further include one or more of: the minimum value for each PSI level of the multiple PSI levels (e.g., at 806) or the maximum value for each PSI level of the multiple PSI levels (e.g., at 808).

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor (or processing circuitry) 1524 (also referred to as a modem) coupled to one or more transceivers 1522 (e.g., cellular RF transceiver). The cellular baseband processor(s) (or processing circuitry) 1524 may include at least one on-chip memory (or memory circuitry) 1524′. In some aspects, the apparatus 1504 may further include one or more subscriber identity modules (SIM) cards 1520 and at least one application processor (or processing circuitry) 1506 coupled to a secure digital (SD) card 1508 and a screen 1510. The application processor(s) (or processing circuitry) 1506 may include on-chip memory (or memory circuitry) 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) (or processing circuitry) 1524 communicates through the transceiver(s) 1522 via one or more antennas 1580 with the UE 104 and/or with an RU associated with a network entity 1502. The cellular baseband processor(s) (or processing circuitry) 1524 and the application processor(s) (or processing circuitry) 1506 may each include a computer-readable medium/memory (or memory circuitry) 1524′, 1506′, respectively. The additional memory modules 1526 may also be considered a computer-readable medium/memory (or memory circuitry). Each computer-readable medium/memory (or memory circuitry) 1524′, 1506′, 1526 may be non-transitory. The cellular baseband processor(s) (or processing circuitry) 1524 and the application processor(s) (or processing circuitry) 1506 are each responsible for general processing, including the execution of software stored on the computer-readable medium/memory (or memory circuitry). The software, when executed by the cellular baseband processor(s) (or processing circuitry) 1524/application processor(s) (or processing circuitry) 1506, causes the cellular baseband processor(s) (or processing circuitry) 1524/application processor(s) (or processing circuitry) 1506 to perform the various functions described supra. The cellular baseband processor(s) (or processing circuitry) 1524 and the application processor(s) (or processing circuitry) 1506 are configured to perform the various functions described supra based at least in part of the information stored in the memory (or memory circuitry). That is, the cellular baseband processor(s) (or processing circuitry) 1524 and the application processor(s) (or processing circuitry) 1506 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1524/application processor(s) (or processing circuitry) 1506 when executing software. The cellular baseband processor(s) (or processing circuitry) 1524/application processor(s) (or processing circuitry) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) (or processing circuitry) 1524 and/or the application processor(s) (or processing circuitry) 1506, and in another configuration, the apparatus 1504 may be the entire UE (e.g., see UE 350 of FIG. 3) and include the additional modules of the apparatus 1504.

As discussed supra, the component 198 may be configured to determine a discard configuration for a discard process based on PDU set importance (PSI) associated with a set of DRBs, where the discard configuration includes a discard timer and discard information for each DRB in the set of DRBs; and transmit, for a network entity based on the discard configuration, one or more data packets over the set of DRBs. The component 198 may be further configured to perform any of the aspects described in connection with the flowcharts in FIG. 11 and FIG. 12, and/or performed by the UE 1002 in FIG. 10. The component 198 may be within the cellular baseband processor(s) (or processing circuitry) 1524, the application processor(s) (or processing circuitry) 1506, or both the cellular baseband processor(s) (or processing circuitry) 1524 and the application processor(s) (or processing circuitry) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) (or processing circuitry) 1524 and/or the application processor(s) (or processing circuitry) 1506, includes means for determining a discard configuration for a discard process based on PDU set importance (PSI) associated with a set of DRBs, where the discard configuration includes a discard timer and discard information for each DRB in the set of DRBs, and means for transmitting, for a network entity based on the discard configuration, one or more data packets over the set of DRBs. The apparatus 1504 may further include means for performing any of the aspects described in connection with the flowcharts in FIG. 11 and FIG. 12, and/or aspects performed by the UE 1002 in FIG. 10. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

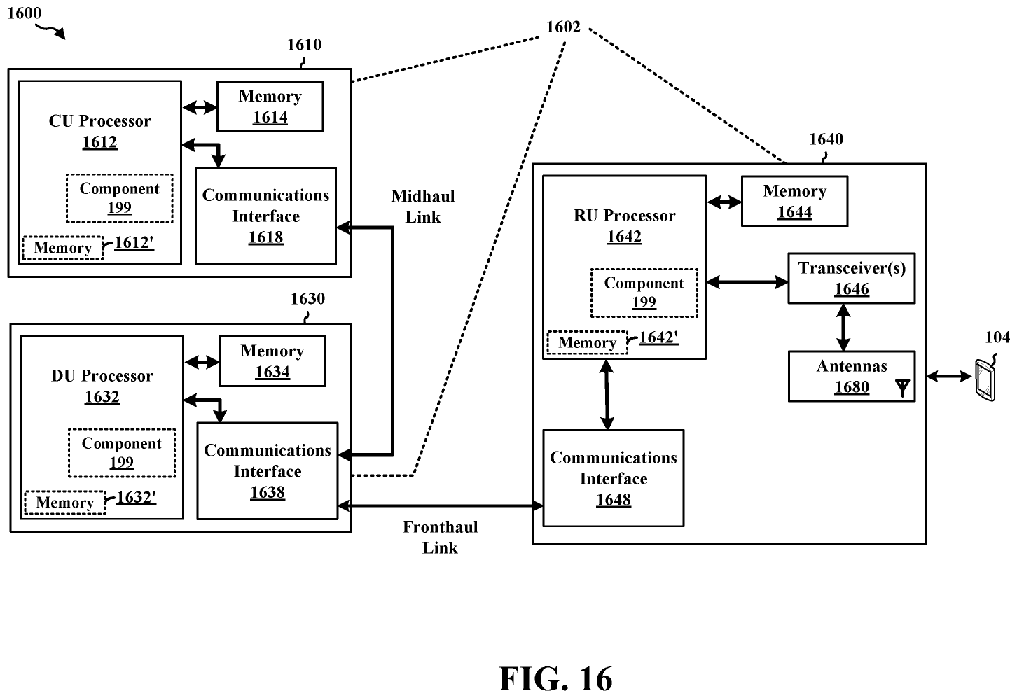

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor (or processing circuitry) 1612. The CU processor(s) (or processing circuitry) 1612 may include on-chip memory (or memory circuitry) 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor (or processing circuitry) 1632. The DU processor(s) (or processing circuitry) 1632 may include on-chip memory (or memory circuitry) 1632′. In some aspects, the DU 1630 may further include additional memory modules 1634 and a communications interface 1638. The DU 1630 communicates with the RU 1640 through a fronthaul link. The RU 1640 may include at least one RU processor (or processing circuitry) 1642. The RU processor(s) (or processing circuitry) 1642 may include on-chip memory (or memory circuitry) 1642′. In some aspects, the RU 1640 may further include additional memory modules 1644, one or more transceivers 1646, antennas 1680, and a communications interface 1648. The RU 1640 communicates with the UE 104. The on-chip memory (or memory circuitry) 1612′, 1632′, 1642′ and the additional memory modules 1614, 1634, 1644 may each be considered a computer-readable medium/memory (or memory circuitry). Each computer-readable medium/memory (or memory circuitry) may be non-transitory. Each of the processors (or processing circuitry) 1612, 1632, 1642 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit, for a UE, a network configuration for a discard process based on PDU set importance (PSI) associated with a set of DRBs; and communicate, with the UE based on a discard configuration based on the network configuration, one or more data packets over the set of DRBs, where the discard configuration includes a discard timer and discard information for each DRB in the set of DRBs. The component 199 may be further configured to perform any of the aspects described in connection with the flowcharts in FIG. 13 and FIG. 14, and/or performed by the base station 1004 in FIG. 10. The component 199 may be within one or more processors (or processing circuitry) of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 includes means for transmitting, for a UE, a network configuration for a discard process based on PDU set importance (PSI) associated with a set of DRBs, and means for communicating, with the UE based on a discard configuration based on the network configuration, one or more data packets over the set of DRBs, where the discard configuration includes a discard timer and discard information for each DRB in the set of DRBs. The network entity 1602 may further include means for performing any of the aspects described in connection with the flowcharts in FIG. 13 and FIG. 14, and/or aspects performed by the base station 1004 in FIG. 10. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include determining a discard configuration for a discard process based on PDU set importance (PSI) associated with a set of DRBs, where the discard configuration includes a discard timer and discard information for each DRB in the set of DRBs; and transmitting, for a network entity based on the discard configuration, one or more data packets over the set of DRBs. The methods enable the UE to recommend or autonomously select DRBs for activation or deactivation of PSI-based discard, thereby conserving bandwidth and enabling more efficient use of transmission resources. Additionally, the methods provide differentiated PSI levels and PSI discard timers for discard purposes to ensure that high-priority data is transmitted efficiently, thereby enhancing the user experience in latency-sensitive applications, such as XR applications. By leveraging AI/ML models to determine the discard configuration, the methods enable the UE to adjust the discard configurations based on real-time network conditions autonomously, ensuring wireless communication quality under various network congestion levels and bandwidth availability conditions.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE. The method includes determining a discard configuration for a discard process based on protocol data unit (PDU) set importance (PSI) associated with a set of data radio bearers (DRBs), wherein the discard configuration includes a discard timer and discard information for each DRB in the set of DRBs; and transmitting, for a network entity based on the discard configuration, one or more data packets over the set of DRBs.
Aspect 2 is the method of aspect 1, wherein the discard information for each DRB in the set of DRBs includes one or more of: an activation or deactivation status for each DRB in the set of DRBs for the discard process based on the PSI, or one PSI level from multiple PSI levels for the discard process based on the PSI for each DRB in the set of DRBs.
Aspect 3 is the method of aspect 2, wherein the discard configuration further comprises an amount of data to discard for each PSI level of the multiple PSI levels.
Aspect 4 is the method of aspect 2, wherein the discard configuration further comprises a flow level for the discard process based on the PSI for each DRB in the set of DRBs.
Aspect 5 is the method of any of aspects 1 to 4, wherein determining the discard configuration comprises: determining, based on an artificial intelligence/machine learning (AI/ML) model, the discard configuration.
Aspect 6 is the method of aspect 5, where the method further includes receiving, from the network entity, a functionality configuration, wherein the functionality configuration indicates one of: an activation of the AI/ML model, an inactivation of the AI/ML model, or a fallback or switch to the AI/ML model from a second AI/ML model.
Aspect 7 is the method of aspect 6, wherein the functionality configuration is based on a trigger event, and wherein the trigger event comprises one or more of: a first change in an available bandwidth between the UE and the network entity, a second change in a congestion level between the UE and the network entity, a degradation in a link quality associated with the UE, a first increase in a demand for transmission resources, a second increase in an uplink delay, or a number of discards greater than a discard threshold.
Aspect 8 is the method of any of aspects 1 to 2, where the method further includes indicating, for the network entity, discard preference information for the discard process based on the PSI associated with the set of DRBs; and receiving, from the network entity, a network configuration for the discard process based on the PSI, wherein the network configuration is based on the discard preference information, and wherein determining the discard configuration comprise: determining, based on the network configuration, the discard configuration.
Aspect 9 is the method of aspect 8, wherein indicating the discard preference information for the discard process based on the PSI associated with the set of DRBs comprises: indicating the discard preference information via one or more of: UE assistance information (UAI), a medium access control (MAC)-control element (MAC-CE), uplink control information (UCI), or a packet data convergence protocol (PDCP) control protocol data unit (PDU).
Aspect 10 is the method of aspect 8, where the method further includes receiving, from the network entity, a network request for the discard preference information, and wherein indicating the discard preference information comprises: indicating the discard preference information in response to the network request.
Aspect 11 is the method of aspect 8, wherein the network configuration includes a timer configuration for the discard timer for each DRB in the set of DRBs, and wherein the discard timer included in the discard configuration is based on the timer configuration.
Aspect 12 is the method of aspect 11, wherein the discard preference information comprises discard timer information for the discard process based on the PSI, and wherein the timer configuration is based on the discard timer information.
Aspect 13 is the method of aspect 11, wherein indicating the discard preference information comprises: indicating the discard preference information periodically based on a periodicity.
Aspect 14 is the method of aspect 11, wherein the timer configuration comprises one or more of: a minimum value of the discard timer, or a maximum value of the discard timer.
Aspect 15 is the method of aspect 8, wherein the network configuration further comprises one or more of: a minimum value for each PSI level of the multiple PSI levels, or a maximum value for each PSI level of the multiple PSI levels.
Aspect 16 is the method of aspect 8, wherein the network configuration is based on one or more of: a key performance indicator (KPI), or a change in a congestion level between the network entity and the UE.
Aspect 17 is the method of any of aspects 1 to 16, wherein determining the discard configuration comprises: determining the discard configuration in response to a trigger condition being met, wherein the trigger condition includes one or more of: an increase in a number of discards in uplink protocol data unit (PDU), a first change in a granularity of an PSI level, a second change in an estimated throughput, or a third change in a bandwidth between the UE and the network entity.
Aspect 18 is the method of any of aspects 1 to 17, where the method further includes transmitting, via a medium access control (MAC)-control element (MAC-CE), for the network entity, an update for the discard configuration for the discard process based on the PSI.
Aspect 19 is the method of any of aspects 1 to 18, where the method further includes recording discard records associated with the UE and the network entity; and transmitting the discard records to the network entity, wherein the discard configuration is based on the discard records, and wherein the discard records comprises one or more of: an estimated congestion level between the UE and the network entity, a network-indicated congestion level between the UE and the network entity, a PSI level corresponding to the estimated congestion level or the network-indicated congestion level, PSI discard timer values, a delay status associated with the UE, a discard status associated with the UE, a buffer size for each DRB of the set of DRBs, or a buffer size limit for each PSI level of a set of PSI levels.
Aspect 20 is an apparatus for wireless communication at a UE, comprising: a processing system that includes processor circuitry and memory circuitry that stores code and is coupled with the processor circuitry, the processing system configured to cause the UE to perform the method of one or more of aspects 1-19.
Aspect 21 is an apparatus for wireless communication at a UE, comprising: at least one memory; and at least one processor coupled to the at least one memory and, where the at least one processor, individually or in any combination, is configured to perform the method of any of aspects 1-19.
Aspect 22 is the apparatus for wireless communication at a UE, comprising means for performing each step in the method of any of aspects 1-19.
Aspect 23 is an apparatus of any of aspects 20-22, further comprising a transceiver configured to receive or to transmit in association with the method of any of aspects 1-19.
Aspect 24 is a computer-readable medium (e.g., a non-transitory computer-readable medium) storing computer executable code at a UE, the code when executed by at least one processor causes the at least one processor to, individually or in any combination, perform the method of any of aspects 1-19.
Aspect 25 is a method of wireless communication at a network entity. The method includes transmitting, for a user equipment (UE), a network configuration for a discard process based on protocol data unit (PDU) set importance (PSI) associated with a set of data radio bearers (DRBs); and communicating, with the UE, based on a discard configuration based on the network configuration, one or more data packets over the set of DRBs, wherein the discard configuration includes a discard timer and discard information for each DRB in the set of DRBs.
Aspect 26 is the method of aspect 25, where the method further includes receiving, from the UE, discard preference information for the discard process based on the PSI associated with the set of DRBs, wherein the network configuration is based on the discard preference information.
Aspect 27 is the method of any of aspects 25 to 26, wherein the discard information for each DRB in the set of DRBs includes one or more of: an activation or deactivation status for each DRB in the set of DRBs for the discard process based on the PSI, or one PSI level from multiple PSI levels for the discard process based on the PSI for each DRB in the set of DRBs.
Aspect 28 is the method of aspect 27, wherein the discard configuration further comprises one or more of: an amount of data to discard for each PSI level of the multiple PSI levels, or a flow level for the discard process based on the PSI for each DRB in the set of DRBs.
Aspect 29 is the method of aspect 27, wherein the discard configuration is based on an artificial intelligence/machine learning (AI/ML) model.
Aspect 30 is the method of aspect 29, where the method further includes transmit, for the UE, a functionality configuration, wherein the functionality configuration indicates one of: an activation of the AI/ML model, an inactivation of the AI/ML model, or a fallback or switch to the AI/ML model from a second AI/ML model.
Aspect 31 is the method of aspect 30, wherein transmitting the functionality configuration comprises: transmitting the functionality configuration based on a trigger event, wherein the trigger event comprises one or more of: a first change in an available bandwidth between the UE and the network entity, a second change in a congestion level between the UE and the network entity, a degradation in a link quality associated with the UE, a first increase in a demand for transmission resources, a second increase in an uplink delay, or a number of discards greater than a discard threshold.
Aspect 32 is the method of aspect 27, wherein the network configuration includes a timer configuration for the discard timer for each DRB in the set of DRBs, and wherein the discard timer included in the discard configuration is based on the timer configuration.
Aspect 33 is the method of aspect 32, wherein the timer configuration comprises one or more of: a first minimum value of the discard timer, or a first maximum value of the discard timer, and wherein the network configuration further comprises one or more of: a second minimum value for each PSI level of the multiple PSI levels, or a second maximum value for each PSI level of the multiple PSI levels.
Aspect 34 is an apparatus for wireless communication at a network entity, comprising: a processing system that includes processor circuitry and memory circuitry that stores code and is coupled with the processor circuitry, the processing system configured to cause the network entity to perform the method of one or more of aspects 25-33.
Aspect 35 is an apparatus for wireless communication at a network entity, comprising: at least one memory; and at least one processor coupled to the at least one memory and, where the at least one processor, individually or in any combination, is configured to perform the method of any of aspects 25-33.
Aspect 36 is the apparatus for wireless communication at a network entity, comprising means for performing each step in the method of any of aspects 25-33.
Aspect 37 is an apparatus of any of aspects 34-36, further comprising a transceiver configured to receive or to transmit in association with the method of any of aspects 25-33.
Aspect 38 is a computer-readable medium (e.g., a non-transitory computer-readable medium) storing computer executable code at a network entity, the code when executed by at least one processor causes the at least one processor to, individually or in any combination, perform the method of any of aspects 25-33.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
determine a discard configuration for a discard process based on protocol data unit (PDU) set importance (PSI) associated with a set of data radio bearers (DRBs), wherein the discard configuration includes a discard timer and discard information for each DRB in the set of DRBs; and
transmit, for a network entity based on the discard configuration, one or more data packets over the set of DRBs.

2. The apparatus of claim 1, further comprising a transceiver coupled to the at least one processor, wherein to transmit the one or more data packets over the set of DRBs, the at least one processor, individually or in any combination, is configured to cause the UE to transmit the one or more data packets via the transceiver, and wherein the discard information for each DRB in the set of DRBs includes one or more of:
an activation or deactivation status for each DRB in the set of DRBs for the discard process based on the PSI, or
one PSI level from multiple PSI levels for the discard process based on the PSI for each DRB in the set of DRBs.

3. The apparatus of claim 2, wherein the discard configuration further comprises:
an amount of data to discard for each PSI level of the multiple PSI levels.

4. The apparatus of claim 2, wherein the discard configuration further comprises:
a flow level for the discard process based on the PSI for each DRB in the set of DRBs.

5. The apparatus of claim 2, wherein to determine the discard configuration, the at least one processor, individually or in any combination, is configured to cause the UE to:
determine, based on an artificial intelligence/machine learning (AI/ML) model, the discard configuration.

6. The apparatus of claim 5, wherein the at least one processor, individually or in any combination, is further configured to cause the UE to:
receive, from the network entity, a functionality configuration, wherein the functionality configuration indicates one of:
an activation of the AI/ML model,
an inactivation of the AI/ML model, or
a fallback or switch to the AI/ML model from a second AI/ML model.

7. The apparatus of claim 6, wherein the functionality configuration is based on a trigger event, and wherein the trigger event comprises one or more of:
a first change in an available bandwidth between the UE and the network entity,
a second change in a congestion level between the UE and the network entity,
a degradation in a link quality associated with the UE,
a first increase in a demand for transmission resources,
a second increase in an uplink delay, or
a number of discards greater than a discard threshold.

8. The apparatus of claim 2, wherein the at least one processor, individually or in any combination, is further configured to cause the UE to:
indicate, for the network entity, discard preference information for the discard process based on the PSI associated with the set of DRBs; and
receive, from the network entity, a network configuration for the discard process based on the PSI, wherein the network configuration is based on the discard preference information, and
wherein to determine the discard configuration, the at least one processor, individually or in any combination, is configured to cause the UE to:
determine, based on the network configuration, the discard configuration.

9. The apparatus of claim 8, wherein to indicate the discard preference information for the discard process based on the PSI associated with the set of DRBs, the at least one processor, individually or in any combination, is configured to cause the UE to:
indicate the discard preference information via one or more of:
UE assistance information (UAI),
a medium access control (MAC)-control element (MAC-CE),
uplink control information (UCI), or
a packet data convergence protocol (PDCP) control protocol data unit (PDU).

10. The apparatus of claim 8, wherein the at least one processor, individually or in any combination, is configured to cause the UE to:
receive, from the network entity, a network request for the discard preference information, and
wherein to indicate the discard preference information, the at least one processor, individually or in any combination, is configured to cause the UE to:
indicate the discard preference information in response to the network request.

11. The apparatus of claim 8, wherein the network configuration includes a timer configuration for the discard timer for each DRB in the set of DRBs, and wherein the discard timer included in the discard configuration is based on the timer configuration.

12. The apparatus of claim 11, wherein the discard preference information comprises discard timer information for the discard process based on the PSI, and wherein the timer configuration is based on the discard timer information.

13. The apparatus of claim 11, wherein to indicate the discard preference information, the at least one processor, individually or in any combination, is configured to cause the UE to:
indicate the discard preference information periodically based on a periodicity.

14. The apparatus of claim 11, wherein the timer configuration comprises one or more of:
a minimum value of the discard timer, or
a maximum value of the discard timer.

15. The apparatus of claim 8, wherein the network configuration further comprises one or more of:
a minimum value for each PSI level of the multiple PSI levels, or
a maximum value for each PSI level of the multiple PSI levels.

16. The apparatus of claim 8, wherein the network configuration is based on one or more of:
a key performance indicator (KPI), or
a change in a congestion level between the network entity and the UE.

17. The apparatus of claim 1, wherein to determine the discard configuration, the at least one processor, individually or in any combination, is configured to cause the UE to:
determine the discard configuration in response to a trigger condition being met, wherein the trigger condition includes one or more of:
an increase in a number of discards in uplink protocol data unit (PDU),
a first change in a granularity of an PSI level,
a second change in an estimated throughput, or
a third change in a bandwidth between the UE and the network entity.

18. The apparatus of claim 1, wherein the at least one processor, individually or in any combination, is configured to cause the UE to:
transmit, via a medium access control (MAC)-control element (MAC-CE), for the network entity, an update for the discard configuration for the discard process based on the PSI.

19. The apparatus of claim 1, wherein the at least one processor, individually or in any combination, is configured to cause the UE to:
record discard records associated with the UE and the network entity; and
transmit the discard records to the network entity, wherein the discard configuration is based on the discard records, and wherein the discard records comprise one or more of:
an estimated congestion level between the UE and the network entity,
a network-indicated congestion level between the UE and the network entity,
a PSI level corresponding to the estimated congestion level or the network-indicated congestion level,
PSI discard timer values,
a delay status associated with the UE,
a discard status associated with the UE,
a buffer size for each DRB of the set of DRBs, or
a buffer size limit for each PSI level of a set of PSI levels.

20. An apparatus for wireless communication at a network entity, comprising:
at least one memory; and
at least one processor coupled to the at least one memory and, based at least in part on information stored in the at least one memory, the at least one processor, individually or in any combination, is configured to cause the network entity to:
transmit, for a user equipment (UE), a network configuration for a discard process based on protocol data unit (PDU) set importance (PSI) associated with a set of data radio bearers (DRBs); and
communicate, with the UE based on a discard configuration based on the network configuration, one or more data packets over the set of DRBs, wherein the discard configuration includes a discard timer and discard information for each DRB in the set of DRBs.

21. The apparatus of claim 20, further comprising a transceiver coupled to the at least one processor, wherein to transmit the network configuration, the at least one processor, individually or in any combination, is configured to cause the network entity to transmit the network configuration via the transceiver, and wherein the at least one processor, individually or in any combination, is further configured to cause the network entity to:
receive, from the UE, discard preference information for the discard process based on the PSI associated with the set of DRBs, wherein the network configuration is based on the discard preference information.

22. The apparatus of claim 21, wherein the discard information for each DRB in the set of DRBs includes one or more of:
an activation or deactivation status for each DRB in the set of DRBs for the discard process based on the PSI, or
one PSI level from multiple PSI levels for the discard process based on the PSI for each DRB in the set of DRBs.

23. The apparatus of claim 22, wherein the discard configuration further comprises one or more of:
an amount of data to discard for each PSI level of the multiple PSI levels, or
a flow level for the discard process based on the PSI for each DRB in the set of DRBs.

24. The apparatus of claim 22, wherein the discard configuration is based on an artificial intelligence/machine learning (AI/ML) model.

25. The apparatus of claim 24, wherein the at least one processor, individually or in any combination, is configured to cause the network entity to:
transmit, for the UE, a functionality configuration, wherein the functionality configuration indicates one of:
an activation of the AI/ML model,
an inactivation of the AI/ML model, or
a fallback or switch to the AI/ML model from a second AI/ML model.

26. The apparatus of claim 25, wherein to transmit the functionality configuration, the at least one processor, individually or in any combination, is configured to cause the network entity to:
transmit the functionality configuration based on a trigger event, wherein the trigger event comprises one or more of:
a first change in an available bandwidth between the UE and the network entity,
a second change in a congestion level between the UE and the network entity,
a degradation in a link quality associated with the UE,
a first increase in a demand for transmission resources,
a second increase in an uplink delay, or
a number of discards greater than a discard threshold.

27. The apparatus of claim 22, wherein the network configuration includes a timer configuration for the discard timer for each DRB in the set of DRBs, and wherein the discard timer included in the discard configuration is based on the timer configuration.

28. The apparatus of claim 27, wherein the timer configuration comprises one or more of:
a first minimum value of the discard timer, or
a first maximum value of the discard timer, and
wherein the network configuration further comprises one or more of:
a second minimum value for each PSI level of the multiple PSI levels, or
a second maximum value for each PSI level of the multiple PSI levels.

29. A method of wireless communication at a user equipment (UE), comprising:
determining a discard configuration for a discard process based on protocol data unit (PDU) set importance (PSI) associated with a set of data radio bearers (DRBs), wherein the discard configuration includes a discard timer and discard information for each DRB in the set of DRBs; and
transmitting, for a network entity based on the discard configuration, one or more data packets over the set of DRBs.

30. A method of wireless communication at a network entity, comprising:
transmitting, for a user equipment (UE), a network configuration for a discard process based on protocol data unit (PDU) set importance (PSI) associated with a set of data radio bearers (DRBs); and
communicating, with the UE, based on a discard configuration based on the network configuration, one or more data packets over the set of DRBs, wherein the discard configuration includes a discard timer and discard information for each DRB in the set of DRBs.
